(19) United States
(12) Patent Application Publication
(10) Pub. No.: US 2023/0328559 A1
(43) Pub. Date: Oct. 12, 2023

(54) REPORTING CONFIGURATIONS FOR NEURAL NETWORK-BASED PROCESSING AT A UE

(71) Applicant: QUALCOMM Incorporated, San Diego, CA (US)

(72) Inventors: Alexandros MANOLAKOS, Escondido, CA (US); Pavan Kumar VITTHALADEVUNI, San Diego, CA (US); Taesang YOO, San Diego, CA (US); June NAMGOONG, San Diego, CA (US); Jay Kumar SUNDARARAJAN, San Diego, CA (US); Tingfang JI, San Diego, CA (US); Naga BHUSHAN, San Diego, CA (US); Hwan Joon KWON, San Diego, CA (US); Krishna Kiran MUKKAVILLI, San Diego, CA (US)

(21) Appl. No.: 18/014,445

(22) PCT Filed: Aug. 13, 2021
(86) PCT No.: PCT/US2021/045968

§ 371 Date: Jan. 4, 2023

(30) Foreign Application Priority Data
Aug. 18, 2020 (GR) 20200100493

(51) Int. Cl. H04W 24/08; H04W 24/10; G06N 3/04; G06N 3/08

(52) U.S. Cl. CPC H04W 24/08; H04W 24/10; G06N 3/04; G06N 3/08

(57) ABSTRACT

This disclosure provides systems, devices, apparatus, and methods, including computer programs encoded on storage media, for reporting configurations for neural network-based processing at a UE. A network entity may transmit to the UE a CSI configuration that includes one or more parameters for a neural network and one or more reference signals. The UE may measure the one or more reference signals based on the CSI configuration. A CSI may be based on the one or more parameters and the measurement of the one or more reference signals. The UE may report the CSI to the network entity based on output of the neural network.

### CROSS REFERENCE TO RELATED APPLICATION(S)

This application claims the benefit of and priority to Greek Application No. 20200100493, entitled “Reporting Configurations for Neural Network-based Processing at a UE” and filed on Aug. 18, 2020, which is expressly incorporated by reference herein in its entirety.

### TECHNICAL FIELD

The present disclosure relates generally to communication systems, and more particularly, to encoding a data set using operations of a neural network.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may receive a CSI configuration that includes one or more parameters for a neural network, the CSI configuration associated with one or more reference signals to be measured; measure the one or more reference signals based on the CSI configuration, a CSI being based on the one or more parameters for the neural network received in the CSI configuration and a measurement of the one or more reference signals; and report the CSI to a network entity based on output of the neural network.

In another aspect of the disclosure, a method, a computer-readable medium, and an apparatus are provided. The apparatus may transmit, to a UE, a CSI configuration that includes one or more parameters for a neural network, the CSI configuration associated with one or more reference signals; transmit the one or more reference signals to the UE; and receive CSI from the UE based on the one or more parameters in the CSI configuration and the one or more reference signals.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A is a diagram illustrating an example of an encoding device and a decoding device that use previously stored channel state information, in accordance with various aspects of the present disclosure.

FIG. 4B is a diagram illustrating an example associated with an encoding device and a decoding device, in accordance with various aspects of the present disclosure.

FIGS. 5-8 are diagrams illustrating examples associated with encoding and decoding a data set using a neural network for uplink communication, in accordance with various aspects of the present disclosure.

FIGS. 9-10 are diagrams illustrating example processes associated with encoding a data set using a neural network for uplink communication, in accordance with various aspects of the present disclosure.

FIG. 11 is a communication flow between an encoding device and a decoding device in accordance with aspects of the present disclosure.

FIG. 12 is a flowchart of a method of wireless communication at an encoding device in accordance with aspects of the present disclosure.

FIG. 13 is a flowchart of a method of wireless communication at an encoding device in accordance with aspects of the present disclosure.

FIG. 14 is a flowchart of a method of wireless communication at a decoding device in accordance with aspects of the present disclosure.

FIG. 15 is a flowchart of a method of wireless communication at a decoding device in accordance with aspects of the present disclosure.

FIG. 16 is a diagram illustrating an example of a hardware implementation for an example apparatus.

FIG. 17 is a diagram illustrating an example of a hardware implementation for an example apparatus.

FIG. 18 illustrates example aspects of a CSI configuration.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more examples, the functions described may be implemented in hardware, software, or any combination thereof If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described techniques. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, aggregated or disaggregated components (e.g., associated with a user equipment (UE) and/or a base station), end-user devices, etc. of varying sizes, shapes, and constitution.

Channel state information (CSI) may be reported from a user equipment (UE) to a network entity (e.g., base station, second UE, server, transmit-reception point (TRP), etc.) based on Type 1 and/or Type 2 CSI reporting. Such reporting may include information associated with a channel quality indicator (CQI), precoding matrix indicator (PMI), rank indicator (RI), CSI-RS resource indicator (CRI), synchronization signal block/physical broadcast channel resource indicator (SSBRI), layer indicator (LI), etc. Type 1 CSI reporting may be based on an indication of beam indices selected by the UE and Type 2 CSI reporting may be based on a beam-combination technique where the UE may determine a linear combination of coefficients of various beams for reporting the beam indices and the coefficients used for combining the beams on a (configured) sub-band basis.

In Type 1 and Type 2 reporting configurations, content of the CSI report may be defined by the network entity. That is, the CSI report may be associated with implicit CSI feedback. For implicit CSI feedback, the UE may feedback a desired transmission hypothesis (e.g., based on a precoder matrix W) as well as an outcome of the transmission hypothesis. The precoder matrix may be selected from a set of candidate precoder matrices (e.g., a precoder codebook) which may be applied by the UE to measured CSI-reference signal (CSI-RS) ports for providing the transmission hypothesis.

For explicit CSI feedback, the UE may feedback an indication of a channel state as observed by the UE on a number of antenna ports, regardless of how the reported CSI may have been processed by the network entity that transmitted the data to the UE. Similarly, the network entity may not have received an indication of how the hypothetical transmission is to be processed by the UE on the receiver-side. Accordingly, neural network-based CSI may be implemented to directly indicate the channel and/or interference to the network entity. As subband size may not be fixed in neural network-based CSI, the UE may compress the channel in a more comprehensive form based on greater or lesser degrees of accuracy.

To observe the channel and/or interference for neural network-based CSI reporting, the UE may receive a CSI configuration from the network entity associated with parameters for training a neural network. Based on a received/measured reference signal and the trained neural network, the UE may determine CSI via an output of the neural network and report the CSI to the network entity.

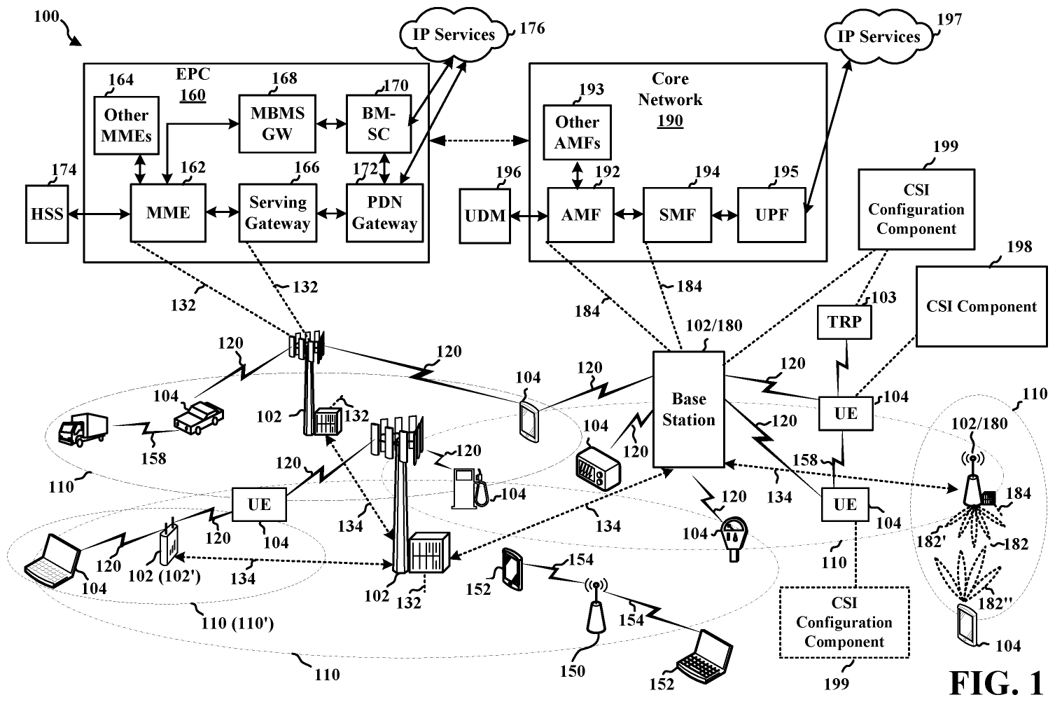

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, a UE 104, or other encoding device, may include a CSI component 198 configured to receive a CSI configuration that includes one or more parameters for a neural network, the CSI configuration associated with one or more reference signals to be measured; measure the one or more reference signals based on the CSI configuration, a CSI being based on the one or more parameters for the neural network received in the CSI configuration and a measurement of the one or more reference signals; and report the CSI to a network entity based on output of the neural network. A base station 102, 180, a TRP 103, another UE 104, or other decoding device, may include a CSI configuration component 199 configured to transmit, to a UE, a CSI configuration that includes one or more parameters for a neural network, the CSI configuration associated with one or more reference signals; transmit the one or more reference signals to the UE; and receive CSI from the UE based on the one or more parameters in the CSI configuration and the one or more reference signals.

Although the following description may be focused on 5G NR, the concepts described herein may be applicable to other similar areas, such as LTE, LTE-A, CDMA, GSM, and other wireless technologies.

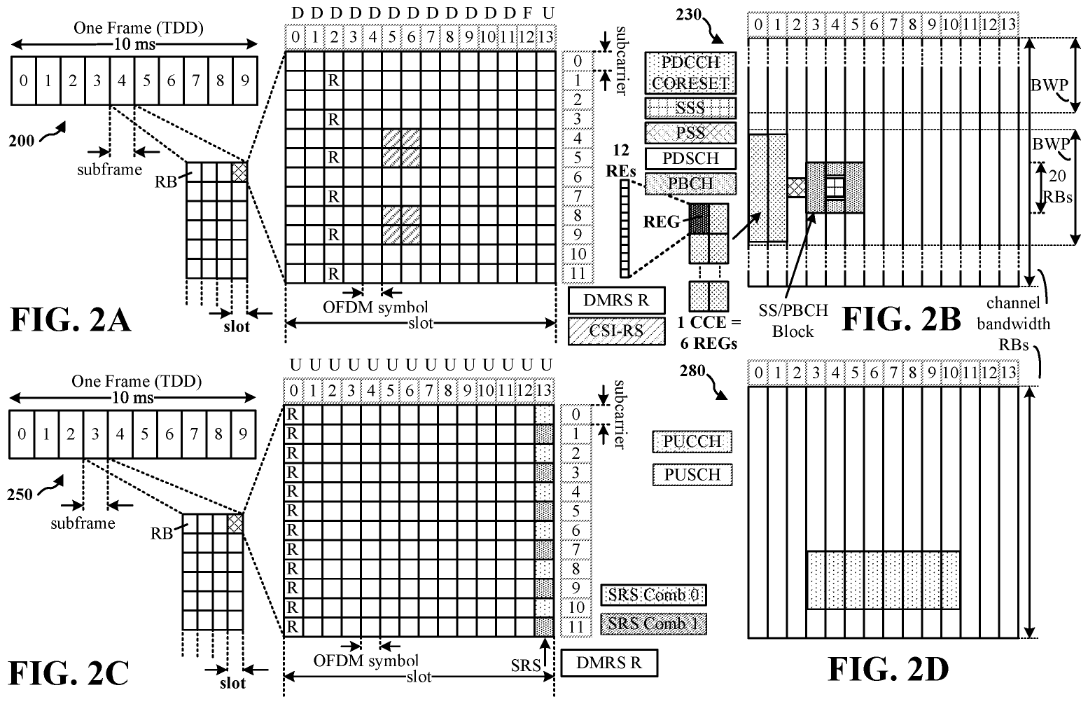

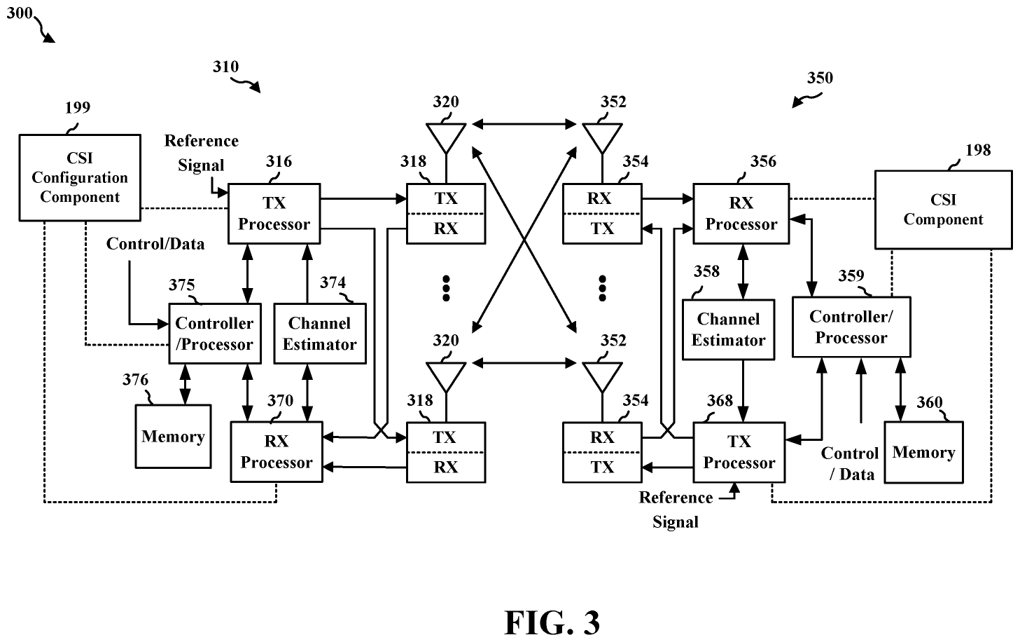

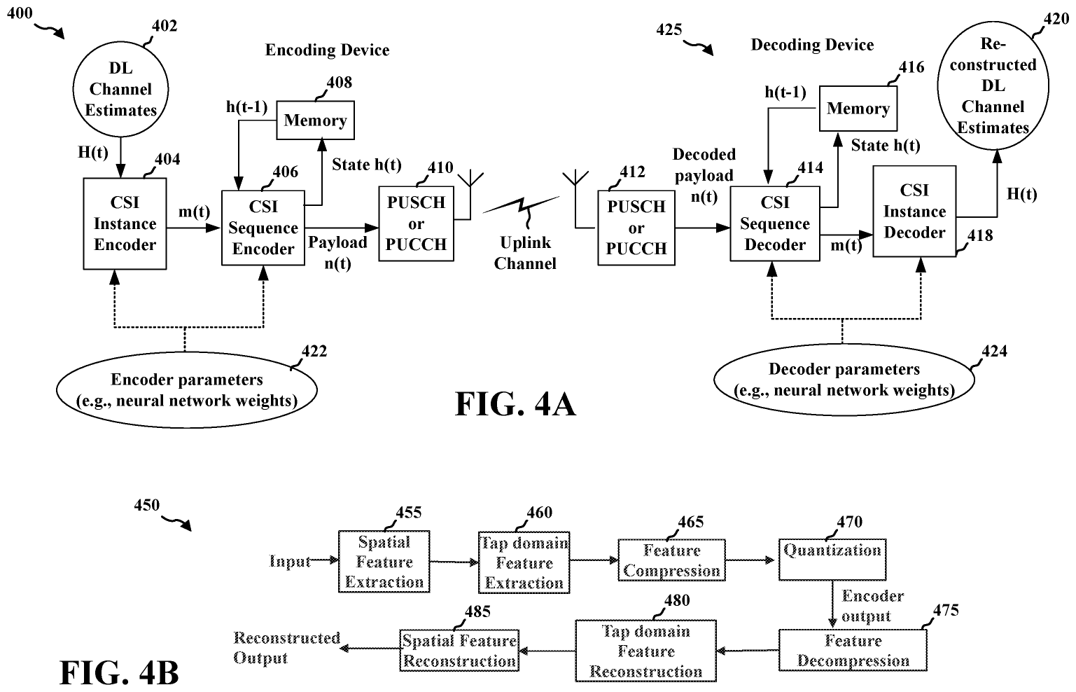

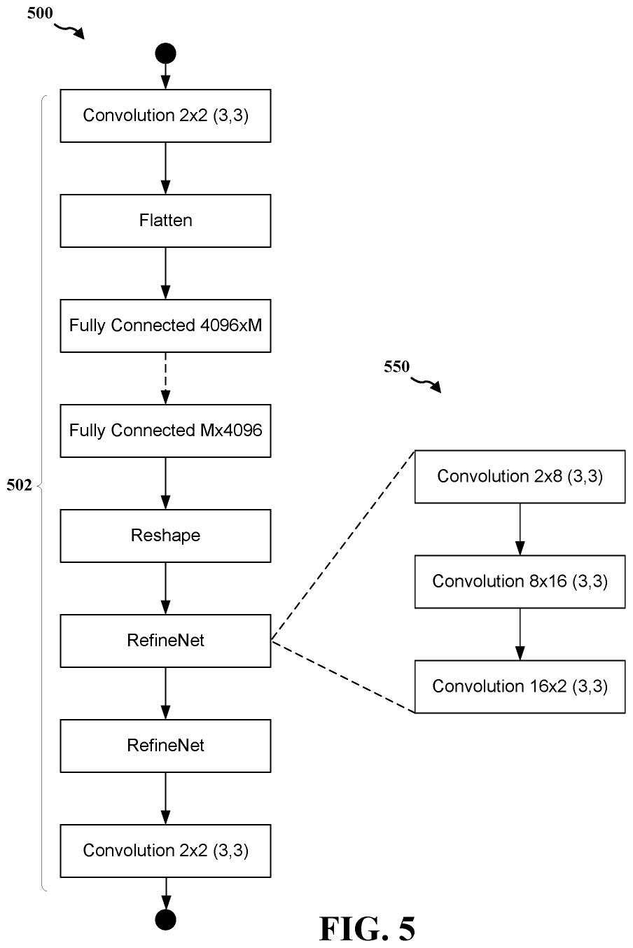

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARD) ACK/NACK feedback. The PUSCH carries data, and may additionally be used to carry a buffer status report (BSR), a power headroom report (PHR), and/or UCI.

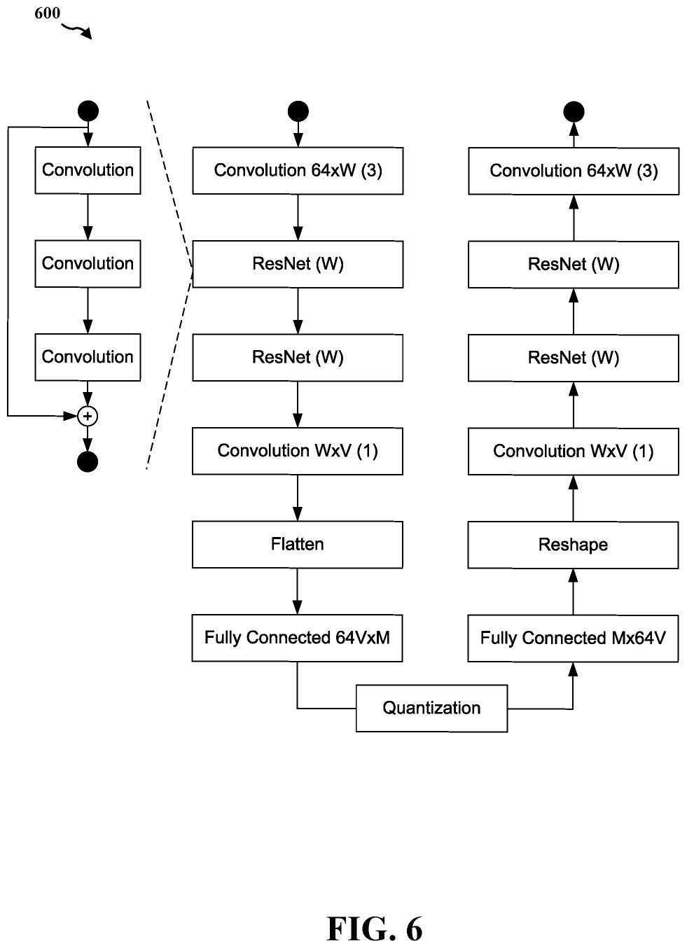

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with CSI component 198 that is configured to receive and apply a CSI configuration that includes one or more parameters for a neural network, e.g., as described in connection with FIG. 1.

At least one of the TX processor 316, the RX processor 370, and the controller/processor 375 may be configured to perform aspects in connection with the CSI configuration component 199 that is configured to transmit, to a UE, or other encoding device, a CSI configuration that includes one or more parameters for a neural network, e.g., as described in connection with FIG. 1.

A wireless receiver may provide various types of channel state information (CSI) to a transmitting device. Among other examples, a UE may perform measurements on downlink signals, such as reference signal, from a base station and may provide a CSI report including any combination of a channel quality indicator (CQI), a precoding matrix indicator (PMI), a rank indicator (RI), a synchronization signal block/physical broadcast channel resource block indicator (SSBRI), a layer indicator (LI). The UE may perform the measurements and determine the CSI based on one or more channel state information reference signals (CSI-RS), SSBs, channel state information interference measurement (CSI-IM) resources, etc. received from the base station. The base station may configure the UE to perform the CSI measurements, e.g., with a CSI measurement configuration. The base station may configure the UE with a CSI resource configuration that indicates the type of reference signal, e.g., a non-zero power CSI-RS (NZP CSI-RS), SSB, CSI-IM resource, etc. The base station may configure the UE with a CSI report configuration that indicates a mapping between the configured CSI measurements and the configured CSI resources and indicates for the UE to provide a CSI report to the base station.

There may be different types of CSI. A first type of CSI (which may be referred to as Type I CSI) may be for beam selection in which the UE selects a set of one or more beams indices (e.g., of beams 182′ or 182″) having better channel measurements and transmits CSI information for the set of beams to the base station.

A second type of CSI (which may be referred to as a Type II CSI) may be for beam combinations of a set of beams. The UE may determine better linear combination coefficients of various beams (e.g., of beams 182′ or 182″) and may transmit the beam indices for the set of beams as well as the coefficients for combining the beams. The UE may provide the coefficients for the beam combinations on a per sub-band basis. For example, Type II CSI feedback may include a CSI report for each configured sub-band.

The present application provides for an additional type of CSI (which may be referred to herein as neural network-based CSI) that uses machine learning or one or more neural networks to compress a channel and feedback the channel to the base station. The CSI may use machine learning or one or more neural networks to measure and provide feedback about interference observed at the UE. The feedback may be provided to a base station, for example, for communication over an access link. In other examples, the feedback may be provided to a transmission reception point (TRP) or to another UE (e.g., for sidelink communication).

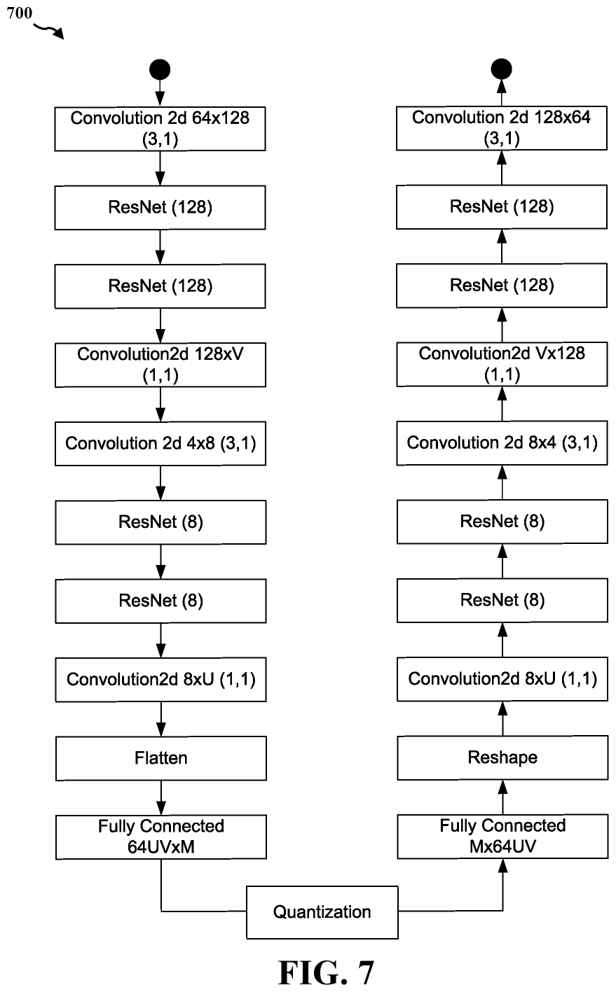

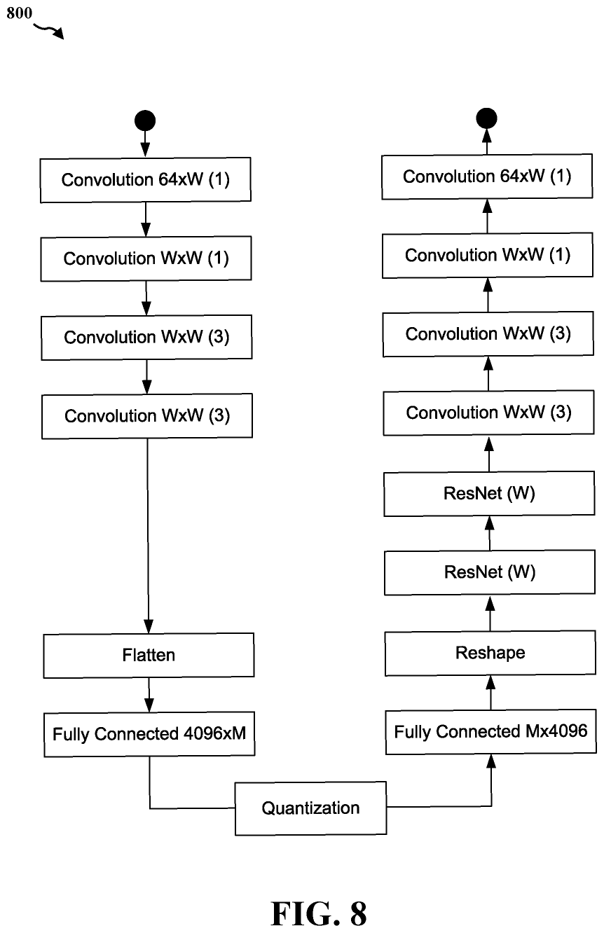

FIG. 4A illustrates an example architecture of components of an encoding device 400 and a decoding device 425 that use previously stored CSI, in accordance with aspects of the present disclosure. In some examples, the encoding device 400 may be a UE (e.g., 104 or 350), and the decoding device 425 may be a base station (e.g., 102, 180, 310), a transmission reception point (TRP) (e.g., TRP 103), another UE (e.g., UE 104), etc. The encoding device 400 and the decoding device 425 may save and use previously stored CSI and may encode and decode a change in the CSI from a previous instance. This may provide for less CSI feedback overhead and may improve performance. The encoding device 400 may also be able to encode more accurate CSI, and neural networks may be trained with the more accurate CSI. The example architecture of the encoding device 400 and the decoding device 425 may be used for the determination, e.g., computation, of CSI and provision of feedback from the encoding device 400 to the decoding device 425 including processing based on a neural network or machine learning.

As illustrated at 402, the encoding device 400 measures downlink channel estimates based on downlink signals from the base station, such as CSI-RS, SSB, CSI-IM resources, etc., that is input for encoding. A downlink channel estimate instance at time t is represented as H(t) and is provided to a CSI instance encoder 404 that encodes the single CSI instance for time t and outputs the encoded CSI instance for time t as m(t) to a CSI sequence encoder 406. The CSI sequence encoder 406 may take Doppler into account.

As shown in FIG. 4A, the CSI instance encoder 404 may encode a CSI instance into intermediate encoded CSI for each DL channel estimate in a sequence of DL channel estimates. The CSI instance encoder 404 (e.g., a feedforward network) may use neural network encoder weights θ. The intermediate encoded CSI may be represented as m(t) [symbol] f_{enc,θ}(H(t)). The CSI sequence encoder 406 may be based on a long short-term memory (LSTM) network, whereas the CSI instance encoder 404 may be based on a feedforward network. In other examples, the CSI sequence encoder 406 may be based on a gated recursive unit network or a recursive unit network. The CSI sequence encoder 406 (e.g., the LSTM network) may determine a previously encoded CSI instance h(t−1) from memory 408 and compare the intermediate encoded CSI m(t) and the previously encoded CSI instance h(t−1) to determine a change n(t) in the encoded CSI. The change n(t) may be part of a channel estimate that is new and may not be predicted by the decoding device. The encoded CSI at this point may be represented by [n(t), h_{enc}(t)] [symbol] g_{enc,θ}(m(t), h_{enc}(t−1)). CSI sequence encoder 406 may provide this change n(t) on the physical uplink shared channel (PUSCH) or the physical uplink control channel (PUCCH), and the encoding device may transmit the change (e.g., information indicating the change) n(t) as the encoded CSI on the UL channel to the decoding device. Because the change is smaller than an entire CSI instance, the encoding device may send a smaller payload for the encoded CSI on the UL channel, while including more detailed information in the encoded CSI for the change. CSI sequence encoder 406 may generate encoded CSI h(t) based at least in part on the intermediate encoded CSI m(t) and at least a portion of the previously encoded CSI instance h(t−1). CSI sequence encoder 406 may save the encoded CSI h(t) in memory 408.

CSI sequence decoder 414 may receive encoded CSI on the PUSCH or PUCCH 412. CSI sequence decoder 414 may determine that only the change n(t) of CSI is received as the encoded CSI. CSI sequence decoder 414 may determine an intermediate decoded CSI m(t) based at least in part on the encoded CSI and at least a portion of a previous intermediate decoded CSI instance h(t−1) from memory 416 and the change n(t). CSI instance decoder 418 may decode the intermediate decoded CSI m(t) into decoded CSI. CSI sequence decoder 414 and CSI instance decoder 418 may use neural network decoder weights ϕ. The intermediate decoded CSI may be represented by [\hat{m}(t), h_{dec}(t)] [symbol] g_{dec,θ}(n(t), h_{dec}(t−1)). CSI sequence decoder 414 may generate decoded CSI h(t) based at least in part on the intermediate decoded CSI m(t) and at least a portion of the previously decoded CSI instance h(t−1). The decoding device may reconstruct a DL channel estimate from the decoded CSI h(t), and the reconstructed channel estimate may be represented as H\hat{ }(t) [symbol] f_(dec, ϕ) (m\hat{ }(t)). CSI sequence decoder 414 may save the decoded CSI h(t) in memory 416.

Because the change n(t) is smaller than an entire CSI instance, the encoding device may send a smaller payload on the UL channel. For example, if the DL channel has changed little from previous feedback, e.g., due to a low Doppler or little movement by the encoding device, an output of the CSI sequence encoder may be rather compact. In this way, the encoding device may take advantage of a correlation of channel estimates over time. In some aspects, because the output is small, the encoding device may include more detailed information in the encoded CSI for the change. In some aspects, the encoding device may transmit an indication (e.g., flag) to the decoding device that the encoded CSI is temporally encoded (e.g., a CSI change). Alternatively, the encoding device may transmit an indication that the encoded CSI is encoded independently of any previously encoded CSI feedback. The decoding device may decode the encoded CSI without using a previously decoded CSI instance. In some aspects, a device, which may include the encoding device or the decoding device, may train a neural network model using a CSI sequence encoder and a CSI sequence decoder.

In some aspects, CSI may be a function of a channel estimate (referred to as a channel response) H and interference N. There may be multiple ways to convey H and N. For example, the encoding device may encode the CSI as H^{-1/2}H. The encoding device may encode H and N separately. The encoding device may partially encode H and N separately, and then jointly encode the two partially encoded outputs. Encoding H and N separately maybe advantageous. Interference and channel variations may occur on different time scales. In a low Doppler scenario, a channel may be steady but interference may still change faster due to traffic or scheduler algorithms. In a high Doppler scenario, the channel may change faster than a scheduler-grouping of UEs. In some aspects, a device, which may include the encoding device or the decoding device, may train a neural network model using a separately encoded H and N.

In some aspects, a reconstructed DL channel H may reflect the DL channel H, and may be referred to as explicit feedback. In some aspects, Ĥ may capture only the information required for the decoding device to derive rank and precoding. CQI may be fed back separately. CSI feedback may be expressed as m(t), or as n(t) in a scenario of temporal encoding. Similar to Type-II CSI feedback, m(t) may be structured to be a concatenation of rank index (RI), beam indices, and coefficients representing amplitudes or phases. In some aspects, m(t) may be a quantized version of a real-valued vector. Beams may be pre-defined (e.g., not obtained by training), or may be a part of the training (e.g., part of θ and ϕ and conveyed to the encoding device or the decoding device).

In some aspects, the decoding device and the encoding device may maintain multiple encoder and decoder networks, each targeting a different payload size (e.g., for varying accuracy vs. UL overhead tradeoff). For each CSI feedback, depending on a reconstruction quality and an uplink budget (e.g., PUSCH payload size), the encoding device may choose, or the decoding device may instruct the encoding device to choose, one of the encoders to construct the encoded CSI. The encoding device may send an index of the encoder along with the CSI based at least in part on an encoder chosen by the encoding device. Similarly, the decoding device and the encoding device may maintain multiple encoder and decoder networks to manage different antenna geometries and channel conditions. Note that while some operations are described for the decoding device and the encoding device, these operations may also be performed by another device, as part of a preconfiguration of encoder and decoder weights and/or structures.

As indicated above, FIG. 4A may be provided as an example. Other examples may differ from what is described with regard to FIG. 4A.

Based at least in part on encoding and decoding a data set using a neural network for uplink communication, the encoding device may transmit CSF with a reduced payload size. This may conserve network resources that may otherwise have been used to transmit a full data set as sampled by the encoding device.

FIG. 4B is a diagram illustrating an example 450 associated with encoding and decoding a data set using a neural network for uplink communication, in accordance with various aspects of the present disclosure. An encoding device (e.g., UE 104, encoding device 400, and/or the like) may be configured to perform one or more operations on samples (e.g., data) received via one or more antennas of the encoding device 400 to compress the samples. A decoding device 425 (e.g., base station 102 or 180, decoding device 425, and/or the like) may be configured to decode the compressed samples to determine information, such as CSF.

In some aspects, the encoding device may identify a feature to compress. In some aspects, the encoding device may perform a first type of operation in a first dimension associated with the feature to compress. The encoding device may perform a second type of operation in other dimensions (e.g., in all other dimensions). For example, the encoding device may perform a fully connected operation on the first dimension and convolution (e.g., pointwise convolution) in all other dimensions.

In some aspects, the reference numbers identify operations that include multiple neural network layers and/or operations. Neural networks of the encoding device and the decoding device may be formed by concatenation of one or more of the referenced operations.

At 455, the encoding device may perform a spatial feature extraction on the data. At 460, the encoding device may perform a tap domain feature extraction on the data. In some aspects, the encoding device may perform the tap domain feature extraction before performing the spatial feature extraction. In some aspects, an extraction operation may include multiple operations. For example, the multiple operations may include one or more convolution operations, one or more fully connected operations, and/or the like, that may be activated or inactive. In some aspects, an extraction operation may include a residual neural network (ResNet) operation.

At 465, the encoding device may compress one or more features that have been extracted. In some aspects, a compression operation may include one or more operations, such as one or more convolution operations, one or more fully connected operations, and/or the like. After compression, a bit count of an output may be less than a bit count of an input.

At 470, the encoding device may perform a quantization operation. In some aspects, the encoding device may perform the quantization operation after flattening the output of the compression operation and/or performing a fully connected operation after flattening the output.

At 475, the decoding device may perform a feature decompression. At 480, the decoding device may perform a tap domain feature reconstruction. At 485, the decoding device may perform a spatial feature reconstruction. In some aspects, the decoding device may perform spatial feature reconstruction before performing tap domain feature reconstruction. After the reconstruction operations, the decoding device may output the reconstructed version of the encoding device's input.

In some aspects, the decoding device may perform operations in an order that is opposite to operations performed by the encoding device. For example, if the encoding device follows operations (a, b, c, d), the decoding device may follow inverse operations (D, C, B, A). In some aspects, the decoding device may perform operations that are fully symmetric to operations of the encoding device. This may reduce a number of bits needed for neural network configuration at the UE. In some aspects, the decoding device may perform additional operations (e.g., convolution operations, fully connected operations, ResNet operations, and/or the like) in addition to operations of the encoding device. In some aspects, the decoding device may perform operations that are asymmetric to operations of the encoding device.

Based at least in part on the encoding device encoding a data set using a neural network for uplink communication, the encoding device (e.g., a UE) may transmit CSF with a reduced payload. This may conserve network resources that may otherwise have been used to transmit a full data set as sampled by the encoding device.

As indicated above, FIG. 4B is provided merely as an example. Other examples may differ from what is described with regard to FIG. 4B.

The neural network-based CSI based on machine learning or a neural network, such as described in connection with FIG. 4A, may compress the downlink channel in a more comprehensive manner. For example, in Type II CSI, a sub-band size may be fixed for all sub-bands for which the UE reports CSI. For example, the sub-band granularity (e.g., sub-band size) may not be a function of a sub-band index within a bandwidth part (BWP). For some frequency bands, the sub-band size may provide more granularity than is needed. In other frequency bands, the sub-band size may not provide enough granularity. The neural network-based CSI may address the problems of a fixed sub-band size by providing CSI over an entire channel, for example. The neural network-based CSI may be configured to compress some sub-bands with greater or lesser accuracy. The neural network-based CSI may also provide benefits for multiple user-multiple input multiple output (MU-MIMO) wireless communication, e.g., at a base station. The neural network-based CSI provides direct information about the channel and the interference and allows the decoding device (such as a base station) to better group receivers (e.g., UEs).

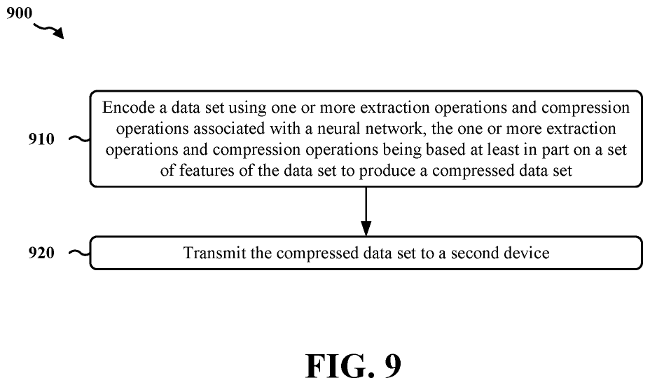

FIG. 5 is a diagram illustrating an example 500 associated with an encoding device and a decoding device, in accordance with various aspects of the present disclosure. The encoding device (e.g., UE 102, 350, encoding device 400, and/or the like) may be configured to perform one or more operations on data to compress the data. The decoding device (e.g., base station 102, 180, 310, decoding device 425, and/or the like) may be configured to decode the compressed data to determine information.

As used herein, a “layer” of a neural network is used to denote an operation on input data. For example, a convolution layer, a fully connected layer, and/or the like may denote associated operations on data that is input into a layer. A convolution A×B operation refers to an operation that converts a number of input features A into a number of output features B. “Kernel size” refers to a number of adjacent coefficients that are combined in a dimension.

As used herein, “weight” is used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values.

As shown in the example 500, the encoding device may perform a convolution operation on samples. For example, the encoding device may receive a set of bits structured as a 2×64×32 data set that indicates IQ sampling for tap features (e.g., associated with multipath timing offsets) and spatial features (e.g., associated with different antennas of the encoding device). The convolution operation may be a 2×2 operation with kernel sizes of 3 and 3 for the data structure. The output of the convolution operation may be input to a batch normalization (BN) layer followed by a LeakyReLU activation, giving an output data set having dimensions 2×64×32. The encoding device may perform a flattening operation to flatten the bits into a 4096 bit vector. The encoding device may apply a fully connected operation, having dimensions 4096×M, to the 4096 bit vector to output a payload of M bits. The encoding device may transmit the payload of M bits to the decoding device.

The decoding device may apply a fully connected operation, having dimensions M×4096, to the M bit payload to output a 4096 bit vector. The decoding device may reshape the 4096 bit vector to have dimension 2×64×32. The decoding device may apply one or more refinement network (RefineNet) operations on the reshaped bit vector. For example, a RefineNet operation may include application of a 2×8 convolution operation (e.g., with kernel sizes of 3 and 3) with output that is input to a BN layer followed by a LeakyReLU activation that produces an output data set having dimensions 8×64×32, application of an 8×16 convolution operation (e.g., with kernel sizes of 3 and 3) with output that is input to a BN layer followed by a LeakyReLU activation that produces an output data set having dimensions 16×64×32, and/or application of a 16×2 convolution operation (e.g., with kernel sizes of 3 and 3) with output that is input to a BN layer followed by a LeakyReLU activation that produces an output data set having dimensions 2×64×32. The decoding device may also apply a 2×2 convolution operation with kernel sizes of 3 and 3 to generate decoded and/or reconstructed output.

As indicated above, FIG. 5 is provided merely as an example. Other examples may differ from what is described with regard to FIG. 5.

As described herein, an encoding device operating in a network may measure reference signals and/or the like to report to a decoding device. For example, a UE may measure reference signals during a beam management process to report channel state feedback (CSF), may measure received power of reference signals from a serving cell and/or neighbor cells, may measure signal strength of inter-radio access technology (e.g., WiFi) networks, may measure sensor signals for detecting locations of one or more objects within an environment, and/or the like. However, reporting this information to the network entity may consume communication and/or network resources.

In some aspects described herein, an encoding device (e.g., a UE) may train one or more neural networks to learn dependence of measured qualities on individual parameters, isolate the measured qualities through various layers of the one or more neural networks (also referred to as “operations”), and compress measurements in a way that limits compression loss.

In some aspects, the encoding device may use a nature of a quantity of bits being compressed to construct a process of extraction and compression of each feature (also referred to as a dimension) that affects the quantity of bits. In some aspects, the quantity of bits may be associated with sampling of one or more reference signals and/or may indicate channel state information.

FIG. 6 is a diagram illustrating an example 600 associated with encoding and decoding a data set using a neural network for uplink communication, in accordance with various aspects of the present disclosure. An encoding device (e.g., UE 120, encoding device 300, and/or the like) may be configured to perform one or more operations on samples (e.g., data) received via one or more antennas of the encoding device to compress the samples. A decoding device (e.g., base station 102, 180, 310, and/or the like) may be configured to decode the compressed samples to determine information, such as CSF.

As shown by example 600, the encoding device may receive sampling from antennas. For example, the encoding device may receive a 64×64 dimension data set based at least in part on a number of antennas, a number of samples per antenna, and a tap feature.

The encoding device may perform a spatial feature extraction, a short temporal (tap) feature extraction, and/or the like. In some aspects, this may be accomplished through the use of a 1-dimensional convolutional operation, that is fully connected in the spatial dimension (to extract the spatial feature) and simple convolution with a small kernel size (e.g., 3) in the tap dimension (to extract the short tap feature). Output from such a 64×W 1-dimensional convolution operation may be a W×64 matrix.

The encoding device may perform one or more ResNet operations. The one or more ResNet operations may further refine the spatial feature and/or the temporal feature. In some aspects, a ResNet operation may include multiple operations associated with a feature. For example, a ResNet operation may include multiple (e.g., 3) 1-dimensional convolution operations, a skip connection (e.g., between input of the ResNet and output of the ResNet to avoid application of the 1-dimensional convolution operations), a summation operation of a path through the multiple 1-dimensional convolution operations and a path through the skip connection, and/or the like. In some aspects, the multiple 1-dimensinoal convolution operations may include a W×256 convolution operation with kernel size 3 with output that is input to a BN layer followed by a LeakyReLU activation that produces an output data set of dimension 256×64, a 256×512 convolution operation with kernel size 3 with output that is input to a BN layer followed by a LeakyReLU activation that produces an output data set of dimension 512×64, and 512×W convolution operation with kernel size 3 that outputs a BN data set of dimension W×64. Output from the one or more ResNet operations may be a W×64 matrix.

The encoding device may perform a W×V convolution operation on output from the one or more ResNet operations. The W×V convolution operation may include a pointwise (e.g., tap-wise) convolution operation. The W×V convolution operation may compress spatial features into a reduced dimension for each tap. The W×V convolution operation has an input of W features and an output of V features. Output from the W×V convolution operation may be a V×64 matrix.

The encoding device may perform a flattening operation to flatten the V×64 matrix into a 64V element vector. The encoding device may perform a 64V×M fully connected operation to further compress the spatial-temporal feature data set into a low dimension vector of size M for transmission over-the-air to the decoding device. The encoding device may perform quantization before the over-the-air transmission of the low dimension vector of size M to map sampling of the transmission into discrete values for the low dimension vector of size M.

The decoding device may perform an M×64V fully connected operation to decompress the low dimension vector of size M into a spatial-temporal feature data set. The decoding device may perform a reshaping operation to reshape the 64V element vector into a 2-dimensional V×64 matrix. The decoding device may perform a V×W (with a kernel size of 1) convolution operation on output from the reshaping operation. The V×W convolution operation may include a pointwise (e.g., tap-wise) convolution operation. The V×W convolution operation may decompress spatial features from a reduced dimension for each tap. The V×W convolution operation has an input of V features and an output of W features. Output from the V×W convolution operation may be a W×64 matrix.

The decoding device may perform one or more ResNet operations. The one or more ResNet operations may further decompress the spatial feature and/or the temporal feature. In some aspects, a ResNet operation may include multiple (e.g., 3) 1-dimensional convolution operations, a skip connection (e.g., to avoid application of the 1-dimensional convolution operations), a summation operation of a path through the multiple convolution operations and a path through the skip connection, and/or the like. Output from the one or more ResNet operations may be a W×64 matrix.

The decoding device may perform a spatial and temporal feature reconstruction. In some aspects, this may be accomplished through the use of a 1-dimensional convolutional operation that is fully connected in the spatial dimension (e.g., to reconstruct the spatial feature) and simple convolution with a small kernel size (e.g., 3) in the tap dimension (e.g., to reconstruct the short tap feature). Output from the 64×W convolution operation may be a 64×64 matrix.

In some aspects, values of M, W, and/or V may be configurable to adjust weights of the features, payload size, and/or the like.

As indicated above, FIG. 6 is provided merely as an example. Other examples may differ from what is described with regard to FIG. 6.

FIG. 7 is a diagram illustrating an example 700 associated with encoding and decoding a data set using a neural network for uplink communication, in accordance with various aspects of the present disclosure. An encoding device (e.g., UE 120, encoding device 300, and/or the like) may be configured to perform one or more operations on samples (e.g., data) received via one or more antennas of the encoding device to compress the samples. A decoding device (e.g., base station 102, 180, 310, and/or the like) may be configured to decode the compressed samples to determine information, such as CSF. As shown by example 700, features may be compressed and decompressed in sequence. For example, the encoding device may extract and compress features associated with the input to produce a payload, and then the decoding device may extract and compress features associated with the payload to reconstruct the input. The encoding and decoding operations may be symmetric (as shown) or asymmetric.

As shown by example 700, the encoding device may receive sampling from antennas. For example, the encoding device may receive a 256×64 dimension data set based at least in part on a number of antennas, a number of samples per antenna, and a tap feature. The encoding device may reshape the data to a (64×64×4) data set.

The encoding device may perform a 2-dimensional 64×128 convolution operation (e.g., with kernel sizes of 3 and 1). In some aspects, the 64×128 convolution operation may perform a spatial feature extraction associated with the decoding device antenna dimension, a short temporal (tap) feature extraction associated with the decoding device (e.g., base station) antenna dimension, and/or the like. In some aspects, this may be accomplished through the use of a 2-dimensional convolutional layer that is fully connected in a decoding device antenna dimension, a simple convolutional operation with a small kernel size (e.g., 3) in the tap dimension and a small kernel size (e.g., 1) in the encoding device antenna dimension. Output from the 64×W convolution operation may be a (128×64×4) dimension matrix.

The encoding device may perform one or more ResNet operations. The one or more ResNet operations may further refine the spatial feature associated with the decoding device and/or the temporal feature associated with the decoding device. In some aspects, a ResNet operation may include multiple operations associated with a feature. For example, a ResNet operation may include multiple (e.g., 3) 2-dimensional convolution operations, a skip connection (e.g., between input of the ResNet and output of the ResNet to avoid application of the 2-dimensional convolution operations), a summation operation of a path through the multiple 2-dimensional convolution operations and a path through the skip connection, and/or the like. In some aspects, the multiple 2-dimensional convolution operations may include a W×2W convolution operation (e.g., with kernel sizes 3 and 1) with output that is input to a BN layer followed by a LeakyReLU activation that produces an output data set of dimension 2W×64×V, a 2W×4W convolution operation with kernel sizes 3 and 1 with output that is input to a BN layer followed by a LeakyReLU activation that produces an output data set of dimension 4W×64×V, and 4W×W convolution operation (e.g., with kernel sizes 3 and 1) that outputs a BN data set of dimension (128×64×4). Output from the one or more ResNet operations may be a (128×64×4) dimension matrix.

The encoding device may perform a 2-dimensional 128×V convolution operation (e.g., with kernel sizes of 1 and 1) on output from the one or more ResNet operations. The 128×V convolution operation may include a pointwise (e.g., tap-wise) convolution operation. The W×V convolution operation may compress spatial features associated with the decoding device into a reduced dimension for each tap. Output from the 128×V convolution operation may be a (4×64×V) dimension matrix.

The encoding device may perform a 2-dimensional 4×8 convolution operation (e.g., with kernel sizes of 3 and 1). In some aspects, the 4×8 convolution operation may perform a spatial feature extraction associated with the encoding device antenna dimension, a short temporal (tap) feature extraction associated with the encoding device antenna dimension, and/or the like. Output from the 4×8 convolution operation may be a (8×64×V) dimension matrix.

The encoding device may perform one or more ResNet operations. The one or more ResNet operations may further refine the spatial feature associated with the encoding device and/or the temporal feature associated with the encoding device. In some aspects, a ResNet operation may include multiple operations associated with a feature. For example, a ResNet operation may include multiple (e.g., 3) 2-dimensional convolution operations, a skip connection (e.g., to avoid application of the 2-dimensional convolution operations), a summation operation of a path through the multiple 2-dimensional convolution operations and a path through the skip connection, and/or the like. Output from the one or more ResNet operations may be a (8×64×V) dimension matrix.

The encoding device may perform a 2-dimensional 8×U convolution operation (e.g., with kernel sizes of 1 and 1) on output from the one or more ResNet operations. The 8×U convolution operation may include a pointwise (e.g., tap-wise) convolution operation. The 8×U convolution operation may compress spatial features associated with the decoding device into a reduced dimension for each tap. Output from the 128×V convolution operation may be a (U×64×V) dimension matrix.

The encoding device may perform a flattening operation to flatten the (U×64×V) dimension matrix into a 64UV element vector. The encoding device may perform a 64UV×M fully connected operation to further compress a 2-dimentional spatial-temporal feature data set into a low dimension vector of size M for transmission over-the-air to the decoding device. The encoding device may perform quantization before the over-the-air transmission of the low dimension vector of size M to map sampling of the transmission into discrete values for the low dimension vector of size M.

The decoding device may perform an M×64UV fully connected operation to decompress the low dimension vector of size M into a spatial-temporal feature data set. The decoding device may perform a reshaping operation to reshape the 64UV element vector into a (U×64×V) dimensional matrix. The decoding device may perform a 2-dimensional U×8 (e.g., with kernel of sizes of 1 and 1) convolution operation on output from the reshaping operation. The U×8 convolution operation may include a pointwise (e.g., tap-wise) convolution operation. The U×8 convolution operation may decompress spatial features from a reduced dimension for each tap. Output from the U×8 convolution operation may be a (8×64×V) dimension data set.

The decoding device may perform one or more ResNet operations. The one or more ResNet operations may further decompress the spatial feature and/or the temporal feature associated with the encoding device. In some aspects, a ResNet operation may include multiple (e.g., 3) 2-dimensional convolution operations, a skip connection (e.g., to avoid application of the 2-dimensional convolution operations), a summation operation of a path through the multiple 2-dimensional convolution operations and a path through the skip connection, and/or the like. Output from the one or more ResNet operations may be a (8×64×V) dimension data set.

The decoding device may perform a 2-dimensional 8×4 convolution operation (e.g., with kernel sizes of 3 and 1). In some aspects, the 8×4 convolution operation may perform a spatial feature reconstruction in the encoding device antenna dimension, and a short temporal feature reconstruction, and/or the like. Output from the 8×4 convolution operation may be a (V×64×4) dimension data set.

The decoding device may perform a 2-dimensional V×128 (e.g., with kernel size of 1) convolution operation on output from the 2-dimensional 8×4 convolution operation to reconstruct a tap feature and a spatial feature associated with the decoding device. The V×128 convolution operation may include a pointwise (e.g., tap-wise) convolution operation. The V×128 convolution operation may decompress spatial features associated with the decoding device antennas from a reduced dimension for each tap. Output from the U×8 convolution operation may be a (128×64×4) dimension matrix.

The decoding device may perform one or more ResNet operations. The one or more ResNet operations may further decompress the spatial feature and/or the temporal feature associated with the decoding device. In some aspects, a ResNet operation may include multiple (e.g., 3) 2-dimensional convolution operations, a skip connection (e.g., to avoid application of the 2-dimensional convolution operations), a summation operation of a path through the multiple 2-dimensional convolution operations and a path through the skip connection, and/or the like. Output from the one or more ResNet operations may be a (128×64×4) dimension matrix.

The decoding device may perform a 2-dimensional 128×64 convolution operation (e.g., with kernel sizes of 3 and 1). In some aspects, the 128×64 convolution operation may perform a spatial feature reconstruction associated with the decoding device antenna dimension, a short temporal feature reconstruction, and/or the like. Output from the 128×64 convolution operation may be a (64×64×4) dimension data set.

In some aspects, values of M, V, and/or U may be configurable to adjust weights of the features, payload size, and/or the like. For example, a value of M may be 32, 64, 128, 256, or 512, a value of V may be 16, and/or a value of U may be 1.

As indicated above, FIG. 7 is provided merely as an example. Other examples may differ from what is described with regard to FIG. 7.

FIG. 8 is a diagram illustrating an example 800 associated with encoding and decoding a data set using a neural network for uplink communication, in accordance with various aspects of the present disclosure. An encoding device (e.g., UE 120, encoding device 300, and/or the like) may be configured to perform one or more operations on samples (e.g., data) received via one or more antennas of the encoding device to compress the samples. A decoding device (e.g., base station 102, 180, 310, and/or the like) may be configured to decode the compressed samples to determine information, such as CSF. The encoding device and decoding device operations may be asymmetric. In other words, the decoding device may have a greater number of layers than the decoding device.

As shown by example 800, the encoding device may receive sampling from antennas. For example, the encoding device may receive a 64×64 dimension data set based at least in part on a number of antennas, a number of samples per antenna, and a tap feature.

The encoding device may perform a 64×W convolution operation (e.g., with a kernel size of 1). In some aspects, the 64×W convolution operation may be fully connected in antennas, convolution in taps, and/or the like. Output from the 64×W convolution operation may be a W×64 matrix. The encoding device may perform one or more W×W convolution operations (e.g., with a kernel sizes of 1 or 3). Output from the one or more W×W convolution operations may be a W×64 matrix. The encoding device may perform the convolution operations (e.g., with a kernel size of 1). In some aspects, the one or more W×W convolution operations may perform a spatial feature extraction, a short temporal (tap) feature extraction, and/or the like. In some aspects, the W×W convolution operations may be a series of 1-dimensional convolution operations.

The encoding device may perform a flattening operation to flatten the W×64 matrix into a 64W element vector. The encoding device may perform a 4096×M fully connected operation to further compress the spatial-temporal feature data set into a low dimension vector of size M for transmission over-the-air to the decoding device. The encoding device may perform quantization before the over-the-air transmission of the low dimension vector of size M to map sampling of the transmission into discrete values for the low dimension vector of size M.

The decoding device may perform a 4096×M fully connected operation to decompress the low dimension vector of size M into a spatial-temporal feature data set. The decoding device may perform a reshaping operation to reshape the 6W element vector into a W×64 matrix.

The decoding device may perform one or more ResNet operations. The one or more ResNet operations may decompress the spatial feature and/or the temporal feature. In some aspects, a ResNet operation may include multiple (e.g., 3) 1-dimensional convolution operations, a skip connection (e.g., between input of the ResNet and output of the ResNet to avoid application of the 1-dimensional convolution operations), a summation operation of a path through the multiple 1-dimensional convolution operations and a path through the skip connection, and/or the like. In some aspects, the multiple 1-dimensinoal convolution operations may include a W×256 convolution operation (e.g., with a kernel size of 3) with output that is input to a BN layer followed by a LeakyReLU activation that produces an output data set of dimension 256×64, a 256×512 convolution operation (e.g., with a kernel size of 3) with output that is input to a BN layer followed by a LeakyReLU activation that produces an output data set of dimension 512×64, and 512×W convolution operation (e.g., with a kernel size of 3) that outputs a BN data set of dimension W×64. Output from the one or more ResNet operations may be a W×64 matrix.

The decoding device may perform one or more W×W convolution operations (e.g., with a kernel size of 1 or 3). Output from the one or more W×W convolution operations may be a W×64 matrix. The encoding device may perform the convolution operations (e.g., with a kernel size of 1). In some aspects, the W×W convolution operations may perform a spatial feature reconstruction, a short temporal (tap) feature reconstruction, and/or the like. In some aspects, the W×W convolution operations may be a series of 1-dimensional convolution operations.

The encoding device may perform a W×64 convolution operation (e.g., with a kernel size of 1). In some aspects, the W×64 convolution operation may be a 1-dimensional convolution operation. Output from the 64×W convolution operation may be a 64×64 matrix.

In some aspects, values of M, and/or W may be configurable to adjust weights of the features, payload size, and/or the like.

As indicated above, FIG. 8 is provided merely as an example. Other examples may differ from what is described with regard to FIG. 8.

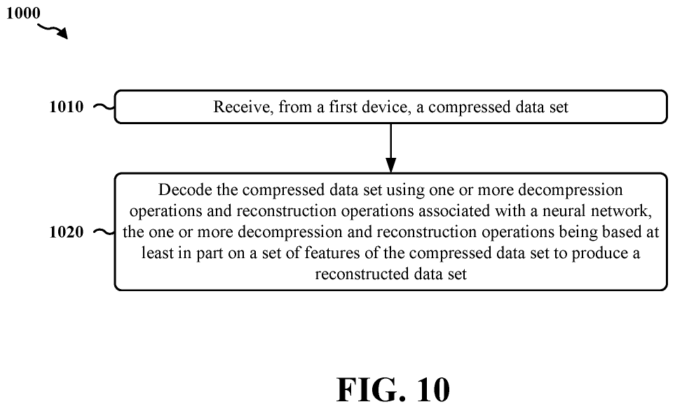

FIG. 9 is a diagram illustrating an example process 900 performed, for example, by a first device, in accordance with various aspects of the present disclosure. Example process 900 corresponds to an example where the first device (e.g., an encoding device, UE 104, and/or the like) performs operations associated with encoding a data set using a neural network.

As shown in FIG. 9, in some aspects, example process 900 may include encoding a data set using one or more extraction operations and compression operations associated with a neural network, the one or more extraction operations and compression operations being based at least in part on a set of features of the data set to produce a compressed data set (block 910). For example, the first device may encode a data set using one or more extraction operations and compression operations associated with a neural network, the one or more extraction operations and compression operations being based at least in part on a set of features of the data set to produce a compressed data set, as described above.

As further shown in FIG. 9, in some aspects, example process 900 may include transmitting the compressed data set to a second device (block 920). For example, the first device may transmit the compressed data set to a second device, as described above.

Example process 900 may include additional aspects, such as any single aspect or any combination of aspects described below and/or in connection with one or more other processes described herein.

In a first aspect, the data set is based at least in part on sampling of one or more reference signals.

In a second aspect, alone or in combination with the first aspect, transmitting the compressed data set to the second device includes transmitting channel state information feedback to the second device.

In a third aspect, alone or in combination with one or more of the first and second aspects, example process 900 includes identifying the set of features of the data set, wherein the one or more extraction operations and compression operations includes a first type of operation performed in a dimension associated with a feature of the set of features of the data set, and a second type of operation, that is different from the first type of operation, performed in remaining dimensions associated with other features of the set of features of the data set.

In a fourth aspect, alone or in combination with one or more of the first through third aspects, the first type of operation includes a one-dimensional fully connected layer operation, and the second type of operation includes a convolution operation.

In a fifth aspect, alone or in combination with one or more of the first through fourth aspects, the one or more extraction operations and compression operations include multiple operations that include one or more of a convolution operation, a fully connected layer operation, or a residual neural network operation.

In a sixth aspect, alone or in combination with one or more of the first through fifth aspects, the one or more extraction operations and compression operations include a first extraction operation and a first compression operation performed for a first feature of the set of features of the data set, and a second extraction operation and a second compression operation performed for a second feature of the set of features of the data set.

In a seventh aspect, alone or in combination with one or more of the first through sixth aspects, example process 900 includes performing one or more additional operations on an intermediate data set that is output after performing the one or more extraction operations and compression operations.

In an eighth aspect, alone or in combination with one or more of the first through seventh aspects, the one or more additional operations include one or more of a quantization operation, a flattening operation, or a fully connected operation.

In a ninth aspect, alone or in combination with one or more of the first through eighth aspects, the set of features of the data set includes one or more of a spatial feature, or a tap domain feature.

In a tenth aspect, alone or in combination with one or more of the first through ninth aspects, the one or more extraction operations and compression operations include one or more of a spatial feature extraction using a one-dimensional convolution operation, a temporal feature extraction using a one-dimensional convolution operation, a residual neural network operation for refining an extracted spatial feature, a residual neural network operation for refining an extracted temporal feature, a pointwise convolution operation for compressing the extracted spatial feature, a pointwise convolution operation for compressing the extracted temporal feature, a flattening operation for flattening the extracted spatial feature, a flattening operation for flattening the extracted temporal feature, or a compression operation for compressing one or more of the extracted temporal feature or the extracted spatial feature into a low dimension vector for transmission.

In an eleventh aspect, alone or in combination with one or more of the first through tenth aspects, the one or more extraction operations and compression operations include a first feature extraction operation associated with one or more features that are associated with a second device, a first compression operation for compressing the one or more features that are associated with the second device, a second feature extraction operation associated with one or more features that are associated with the first device, and a second compression operation for compressing the one or more features that are associated with the first device.

Although FIG. 9 shows example blocks of example process 900, in some aspects, example process 900 may include additional blocks, fewer blocks, different blocks, or differently arranged blocks than those depicted in FIG. 9. Additionally, or alternatively, two or more of the blocks of example process 900 may be performed in parallel.

FIG. 10 is a diagram illustrating an example process 1000 performed, for example, by a second device, in accordance with various aspects of the present disclosure. Example process 1000 corresponds to an example where the second device (e.g., a decoding device, base station 102, 180, and/or the like) performs operations associated with decoding a data set using a neural network.

As shown in FIG. 10, in some aspects, example process 1000 may include receiving, from a first device, a compressed data set (block 1010). For example, the second device may receive, from a first device, a compressed data set, as described above.

As further shown in FIG. 10, in some aspects, example process 1000 may include decoding the compressed data set using one or more decompression operations and reconstruction operations associated with a neural network, the one or more decompression and reconstruction operations being based at least in part on a set of features of the compressed data set to produce a reconstructed data set (block 1020). For example, the second device may decode the compressed data set using one or more decompression operations and reconstruction operations associated with a neural network, the one or more decompression and reconstruction operations being based at least in part on a set of features of the compressed data set to produce a reconstructed data set, as described above.

Example process 1000 may include additional aspects, such as any single aspect or any combination of aspects described below and/or in connection with one or more other processes described herein.

In a first aspect, decoding the compressed data set using the one or more decompression operations and reconstruction operations includes performing the one or more decompression operations and reconstruction operations based at least in part on an assumption that the first device generated the compressed data set using a set of operations that are symmetric to the one or more decompression operations and reconstruction operations, or performing the one or more decompression operations and reconstruction operations based at least in part on an assumption that the first device generated the compressed data set using a set of operations that are asymmetric to the one or more decompression operations and reconstruction operations.

In a second aspect, alone or in combination with the first aspect, the compressed data set is based at least in part on sampling by the first device of one or more reference signals.

In a third aspect, alone or in combination with one or more of the first and second aspects, receiving the compressed data set includes receiving channel state information feedback from the first device.

In a fourth aspect, alone or in combination with one or more of the first through third aspects, the one or more decompression operations and reconstruction operations include a first type of operation performed in a dimension associated with a feature of the set of features of the compressed data set, and a second type of operation, that is different from the first type of operation, performed in remaining dimensions associated with other features of the set of features of the compressed data set.

In a fifth aspect, alone or in combination with one or more of the first through fourth aspects, the first type of operation includes a one-dimensional fully connected layer operation, and wherein the second type of operation includes a convolution operation.

In a sixth aspect, alone or in combination with one or more of the first through fifth aspects, the one or more decompression operations and reconstruction operations include multiple operations that include one or more of a convolution operation, a fully connected layer operation, or a residual neural network operation.

In a seventh aspect, alone or in combination with one or more of the first through sixth aspects, the one or more decompression operations and reconstruction operations include a first operation performed for a first feature of the set of features of the compressed data set, and a second operation performed for a second feature of the set of features of the compressed data set.

In an eighth aspect, alone or in combination with one or more of the first through seventh aspects, example process 1000 includes performing a reshaping operation on the compressed data set.

In a ninth aspect, alone or in combination with one or more of the first through eighth aspects, the set of features of the compressed data set include one or more of a spatial feature, or a tap domain feature.

In a tenth aspect, alone or in combination with one or more of the first through ninth aspects, the one or more decompression operations and reconstruction operations include one or more of a feature decompression operation, a temporal feature reconstruction operation, or a spatial feature reconstruction operation.

In an eleventh aspect, alone or in combination with one or more of the first through tenth aspects, the one or more decompression operations and reconstruction operations include a first feature reconstruction operation performed for one or more features associated with the first device, and a second feature reconstruction operation performed for one or more features associated with the second device.

Although FIG. 10 shows example blocks of example process 1000, in some aspects, example process 1000 may include additional blocks, fewer blocks, different blocks, or differently arranged blocks than those depicted in FIG. 10. Additionally, or alternatively, two or more of the blocks of example process 1000 may be performed in parallel.

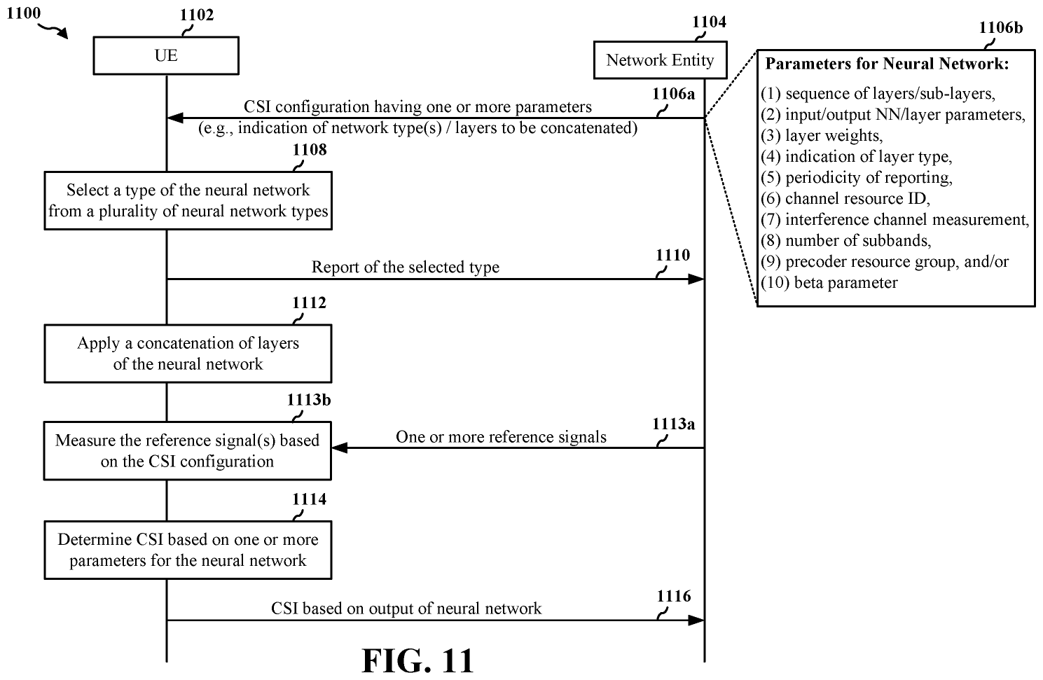

FIG. 11 is a call flow diagram 1100 illustrating communications between a UE 1102 and a network entity 1104. The network entity may be a base station, a second UE, a server, a TRP, etc. Although the UE 1102 and the network entity 1104 are described as an example in the call flow diagram 1100, the aspects may be applied by other encoding devices (e.g., encoding device 400) and decoding devices (e.g., decoding device 425).

At 1106a, the network entity 1104 may transmit CSI having one or more parameters 1106b for a neural network. The one or more parameters 1106b may include (1) a sequence/ordered sequence of layers or sub-layers of the neural network; (2) an input/output parameter for the neural network or for layer(s) or sub-layers of the neural network; (3) layer weights; (4) an indication of a layer type (e.g., residual network block, convolutional layer, fully connected layer, etc.); (5) a periodicity of reporting (e.g., CSI or layer weights); (6) a channel resource identifier (ID) for channels, such as PUCCH, PUSCH, PSCCH, or PSSCH; (7) an indication for the UE 1102 to provide an interference channel measurement via the neural network; (8) a number of subbands for reporting CSI; (9) a precoder resource group (PRG) to be applied for scheduling the UE 1102; and/or (10) a beta (13) parameter indicative of available PUCCH or PUSCH resources for reporting the CSI.

The one or more parameters 1106b transmitted, at 1106a, in the CSI configuration may further include an indication of the neural network type, including layers to be concatenated by the UE 1102. At 1108, the UE 1102 may select a type of the neural network from a plurality of neural network types, if the indication transmitted, at 1106a, indicates a plurality of network types. In some configurations, the one or more parameters 1106b may only indicate one type for the neural network, the type being based on a defined sequence of layers. At 1110, the UE 1102 may report the selected type of the neural network to the network entity 1104.

At 1112, the UE 1102 may apply a concatenation of layers of the neural network (e.g., the neural network selected at 1108). For instance, the UE 1102 may combine layers of the neural network into a group of continuous memory. At 1113a, the network entity 1104 may transmit one or more reference signals and, at 1113b, the UE 1102 may measure the reference signal(s) based on the CSI configuration received at 1106a. At 1114, the UE 1102 may determine CSI based on the one or more parameters 1106b for the neural network received, at 1106a. The UE 1102 may report, at 1116, the CSI to the network entity 1104 based on output of the neural network.

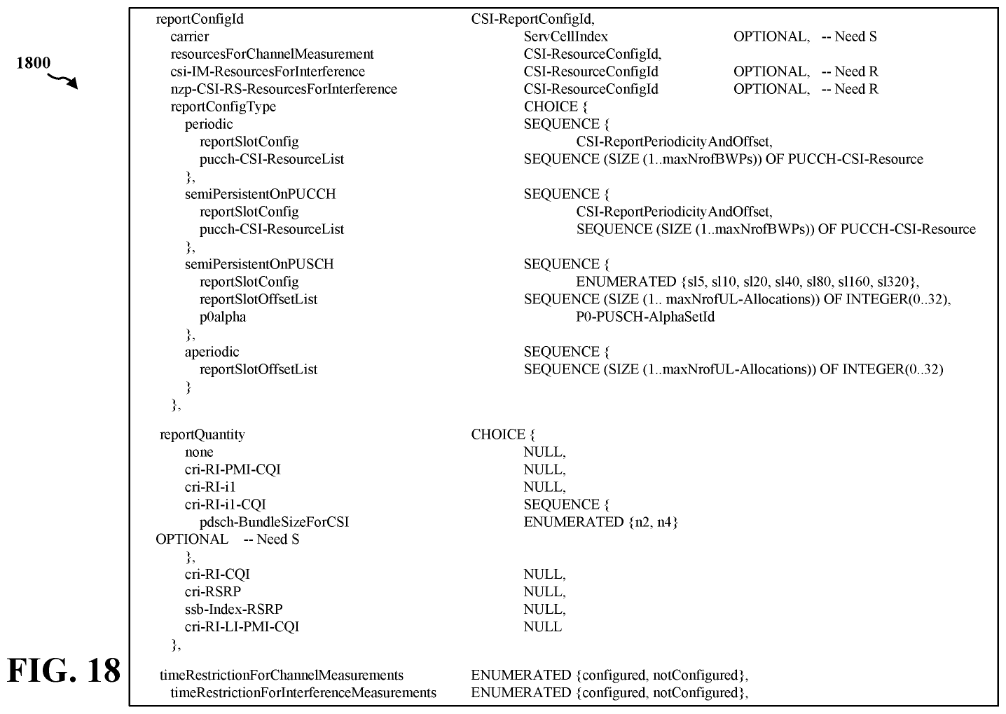

FIG. 18 illustrates a configuration for a CSI report 1800 for implicit CSI feedback. The CSI report 1800 may include information associated with CSI feedback for Type-I CSI and Type-II CSI. For example, the CSI report 1800 may indicate a carrier that includes the measured CSI. The CSI report 1800 may further indicate a periodicity of the reporting (e.g., whether the reporting is periodic, semi-persistent, or aperiodic) as well as a report quantity for information such as cri-RI-PMI-CQI, cri-RI-il, cri-RI-il-CQI, cri-RI-CQI etc. Such information may be used for Type-I and Type-II feedback. Further CSI reporting configurations received by the UE (e.g., associated with neural network-based feedback) may configure the UE to report an output of a neural network or report an intermediate output (e.g., corresponding to a layer) of the neural network.

The ssb-Index-reference signal received power (RSRP) in the CSI report 1800 may be for beam management and the csi-RSRP may be for RSRP reporting. The configuration for the CSI report 1800 may also indicate a frequency at which the UE may provide a report, where the UE may provide the report (e.g., which PDSCH or PUSCH resources to use), what to report (e.g., the report quantity), which carrier to use, and what to measure (e.g., channel and interference). Further, the CSI report 1800 may be indicative of a time restriction. The time restriction may be based on an average value over time for determining the CQI. The averaged CQI may be reported back to the network by the UE.

The content of the CSI report 1800 may be defined in the CSI report configuration. There may be two types of feedback for CSI, including implicit CSI feedback and explicit CSI feedback. For implicit CSI feedback, the UE may feedback a desired transmission hypothesis (e.g., based on a precoder matrix W) as well as an outcome of the transmission hypothesis. The precoder matrix may be selected from a set of candidate precoder matrices (e.g., a precoder codebook) which may be applied to the measured CSI-RS ports to provide the transmission hypothesis. The UE may also report a modulation and coding scheme (MCS) for the transmission hypothesis based on a receiver processing determination.

Referring again to FIGS. 5-8, the examples 500, 600, 700, and 800 each illustrate a neural network and layers associated with neural network-based CSI feedback. Neural network-based CSI feedback may be provided by including further information in the reporting configurations used for Type-I and Type-II CSI feedback. The UE may receive a reporting configuration for the neural network-based CSI feedback that configures the UE based on one or more parameters. For example, the UE may receive an explicit configuration of the neural network of the examples 500, 600, 700, or 800 to be utilized for reporting the channel measurement.

For explicit CSI feedback, the UE may attempt to feedback an indication of a channel state as observed by the UE on a number of antenna ports, regardless of how the reported CSI may have been processed by the network entity (e.g., base station, second UE, server, TRP, etc.) that transmitted the data to the UE. Similarly, the network entity may not have received an indication of how the hypothetical transmission is to be processed by the UE on the Rx-side. The channel portion of the feedback report may include quantized coefficients of the N_{R}×N_{T} channel matrix H, a Tx-side correlation matrix H^{H}H, eigenvectors of the Tx-side correlation matrix, or a quantity determined therefrom, such as a measured RSRP.

An explicit configuration of the neural network of examples 500, 600, 700, or 800 may be included in the reporting configuration received by the UE. In examples, the explicit configuration may indicate specific layers (e.g., any of layers 502 in the example 500 in FIG. 5) of the neural network to be used/configured, an ordered sequence of the layers, input and output vectors/parameters of each layer, a type of each layer (e.g., 1D-conv, FC, RefineNet, etc.), and/or whether a layer includes a sub-layer. If the layer includes a plurality of sub-layers, an additional ordered sequence of the sub-layers may be provided with the input/output parameters (e.g. RefineNet). Such parameters may define a configuration of the neural network for the UE to perform the CSI reporting. That is, the neural network may correspond to a specific CSI reporting/UE configuration. If another CSI reporting configuration explicitly indicates a different neural network, the explicit configuration information may be used to configure the different neural network.

In further examples, the UE may receive an indication of a predefined sequence of layers or neural network types. For instance, a few sets of neural networks (e.g., 4-10 neural networks) may be predefined for the UE, or one or more sets of neural network types/sequences of layers may be configured by the network entity. While the UE may select the one or more sets based on a report configuration ID, the UE may not select all the parameters included in the one or more sets (e.g., number of layers, types, etc.) that the UE may utilize. Rather, the UE may select a predefined configuration from a number of predefined neural network types and the network entity may configure one or more of the predefined neural network types via the reporting configuration.

If a plurality of neural networks is configured, the UE may report the neural network to be utilized by the UE. Thus, the UE may be free to determine the neural network type/layer/configuration of layers that is to be used by the UE for training and reporting. The UE may further include information in the report that indicates the selected configuration. If the plurality of neural networks is configured, a concatenation operation of the layers may also be configured to the UE. For instance, some of the layers may be associated with a specific ID (e.g., a first resnet_block(W) 550 and a second resnet_block(W) 550 may each have an ID of 5). Two layers/blocks that have the same ID may be concatenated.

Thus, to determine the neural network for the CSI reporting, the UE may either receive a reporting configuration for selecting the neural network from a predefined set of neural networks or the UE may receive a reporting configuration that includes an explicit configuration for the UE to determine specific parameters of the neural network.

The reporting configuration may include a periodicity for reporting the output of the neural network and/or a periodicity for reporting a weight of the one or more layers of the neural network. In examples, the periodicity of the reporting may be indicated for each of the layers or a combination of the layers, whereas the periodicity in Type-I and Type-II CSI feedback may only be for an output associated with the CSI. Each sub-block may have a different periodicity. One or more channel resource IDs for channels such as PUCCH, PUSCH, PSCCH, or PSSCH may be used to determine where the UE is to report the output of the neural network and/or the weights of the layers. In an example, a dedicated PUCCH resource may be used for the output of the neural network and other PUCCH resources may be used for other reporting purposes.

The reporting configuration may further include parameters associated with a report quantity. The report quantity may be for configuring the UE to report the output of the neural network, the weights of the one or more layers, or a combination thereof, rather than reporting only combinations of the CRT/RI/PM/CQI, as in Type-I and Type-II. A joint command may indicate both the weights and the output at an end of a future time slot. Further, signaling may be performed to indicate flexibility in reporting a selection of one or more of the weights of the layers or the output of the neural network.

A neural network type/configuration may be utilized for interference channel explicit feedback. While some configurations may be for compressing the channel, interference channel measurement may also be performed by the UE. Thus, the UE may be configured with a neural network for reporting the interference channel measurement. In examples, a same neural network structure may be used as the neural network structure for the channel measurement explicit feedback. For Type-I and Type-II, measurements may be performed based on CSI resources for the channel and CSI resources for the interference. However, for neural network-based CSI, channel measurement may be additionally based on the configured neural network, so that the channel may be compressed. A similar process may be performed for interference channel measurement and compression (e.g., based on a same or different neural network). If a plurality of neural networks is configured, the UE may report the neural network to be utilized by the UE. Thus, the UE may be free to determine the neural network type/layer/configuration of layers that is to be used for training and reporting. If the plurality of neural networks is configured, a concatenation operation of the layers may also be configured to the UE.

In some cases, the neural network type/configuration for the interference feedback may be a separate/different neural network configuration from the channel measurement explicit feedback but, in examples, may have a dependency upon the configuration for the channel measurement explicit feedback. For instance, a number of layers or a type of layers may be the same, an output value of the neural network may be the same, an input/output of each of the layers may be the same, and/or a sequence of the layers may be the same. If separate/different neural networks are not supported for interference channel measurement, an explicit indication may be provided that indicates the interference may be the same.

The reporting configuration may further include parameters associated with a number of subbands to be used by the UE for training and reporting. The UE may support different output vectors for different subbands. For example, the UE may report a different M output vector for each of the subbands. The UE may train different neural networks for the different subbands and report an output of the different neural networks on a per subband basis. The UE may report differentially the M output vectors of each subband. For instance, each subband may be separately compressed such that the UE may differentiate between the subbands for reporting.

In further aspects, the UE may be configured with a PRG that is to be assumed by the UE for reporting the feedback. The network entity may configure the UE based on the report from the UE for scheduling the UE with the same precoder (e.g., every 4 RBs). The UE may perform different processing techniques or train the neural network differently based on an indication of the PRG that the network entity intends to apply for scheduling the UE (e.g., every 2 RBs, every 4 RBs, every 100 RBs, etc.). The UE may use the intended PRG for training the neural network and reporting to the network entity.

For each type of UCI, the UE may utilize a higher layer parameter to determine an amount of resources within a PUSCH to be dedicated for the UCI. The higher layer parameter may be a R parameter. If β is large, more of the PUSCH may be allocated for reporting the CSI feedback. If β is small, less of the PUSCH may be allocated for reporting the CSI feedback and a remainder of the report may be dropped. Thus, the β parameter may control an amount of resources to be dedicated for the PUSCH. A range of values for β may be large, which may allow resources ranging from a small amount to a large amount to be dedicated within the PUSCH for the UCI transmission via different values of β. A number of REs for a UCI type on the PUSCH may depend on a UCI payload size (e.g., including a potential cyclic redundancy check (CRC) overhead) and a spectral efficiency of the PUSCH. In order to reduce excessive resource usage for the UCI, which may result in an insufficient number of REs for uplink data, an upper boundary for the total amount of resources allocated to the UCI may be explicitly controlled by the network entity via the higher layer parameter configured for the UE.

UE reporting may be based on different types of reports, such as reports for the output of the neural network and/or reports for the intermediate levels/layers that may be indicative of trained weights of the layers. Some reports may be associated with different priority levels. For example, if the UE reports the output on a PUSCH, ensuring sufficient resource availability may be needed for higher priority reports. Thus, an increased β value may be applied for providing enough resources within the PUSCH to report the output of the neural network. However, for weights reported in association with the intermediate levels/layers, a lesser amount of resources may be needed. Accordingly, the UE may be configured based on different values of β for different reporting types within neural network-based CSI. A separate β value may be added for different sub-types of the neural network-based CSI. If the UE is reporting the weights of the layers, the β value may be different from cases where the UE reports the output of the neural network. For example, if the UE reports output M of a neural network, a different value of β may be configured to determine the amount of resources within the PUSCH in comparison to instances where the UE may report the weights of the layers. A different β may be configured for each of the layers or each subset of layers.

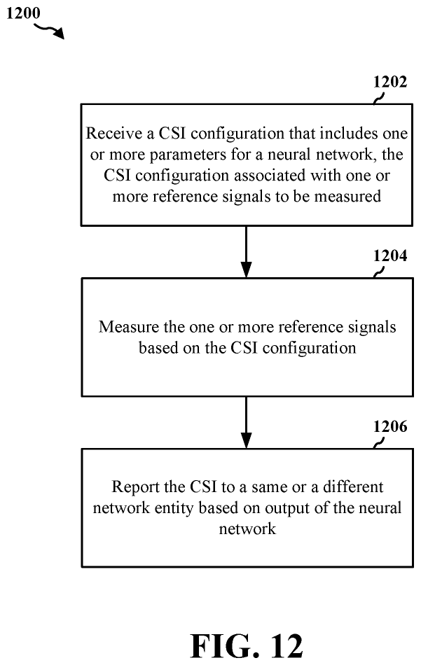

FIG. 12 is a flowchart 1200 of a method of wireless communication. The method may be performed by a UE (e.g., the UE 104/1102; the apparatus 1602, etc.), which may include the memory 360 and which may be the entire UE 104/1102 or a component of the UE 104/1102, such as the TX processor 368, the RX processor 356, and/or the controller/processor 359. The method may be performed to provide improved channel feedback and compression techniques for decreasing interference at a device.

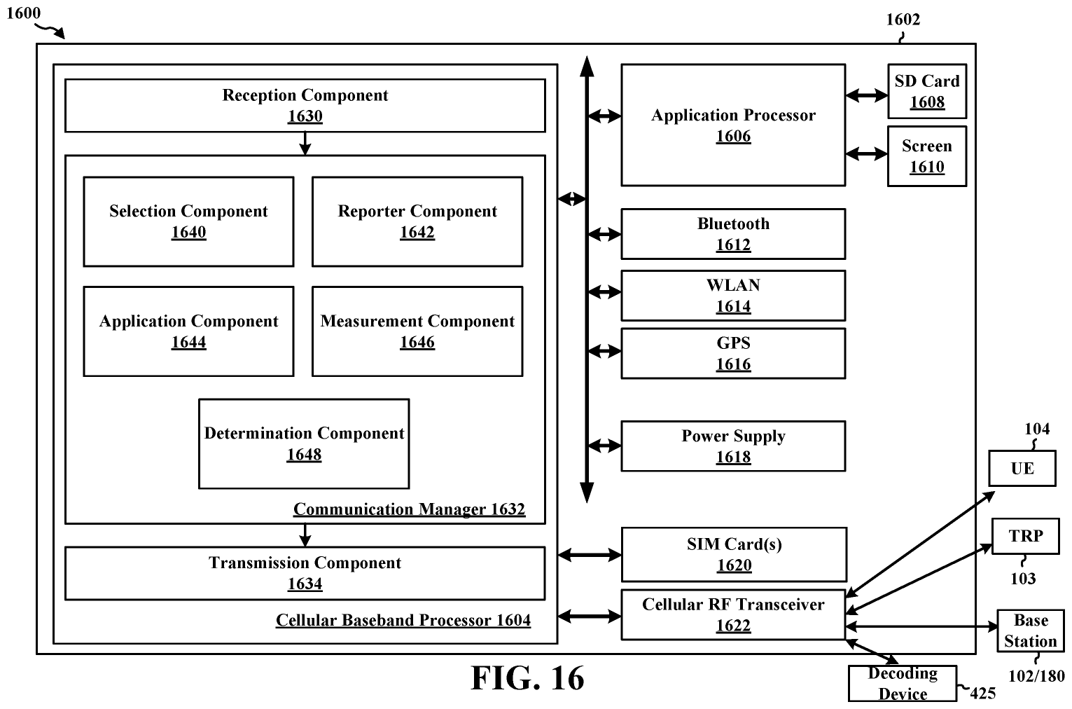

At 1202, the UE may receive a CSI configuration that includes one or more parameters for a neural network, the CSI configuration associated with one or more reference signals to be measured. For example, referring to FIG. 11, the UE 1102 may receive, at 1106a, a CSI configuration having one or more parameters 1106b for the neural network. The UE 1102 may associate the CSI configuration received, at 1106a, with the one or more reference signals received at 1113a. The reception, at 1202, may be performed by the reception component 1630 of the apparatus 1602 in FIG. 16.

At 1204, the UE may measure the one or more reference signals based on the CSI configuration. For example, referring to FIG. 11, the UE 1102 may measure, at 1113b, the reference signal(s) received, at 1113a, based on the CSI configuration received at 1106a. The measurement, at 1204, may be performed by the measurement component 1646 of the apparatus 1602 in FIG. 16.

At 1206, the UE may report the CSI to the network entity based on output of the neural network. For example, referring to FIG. 11, the UE 1102 may report, at 1116, CSI to the network entity 1104 based on the output of the neural network. The reporting, at 1206, may be performed by the reporter component 1642 of the apparatus 1602 in FIG. 16.

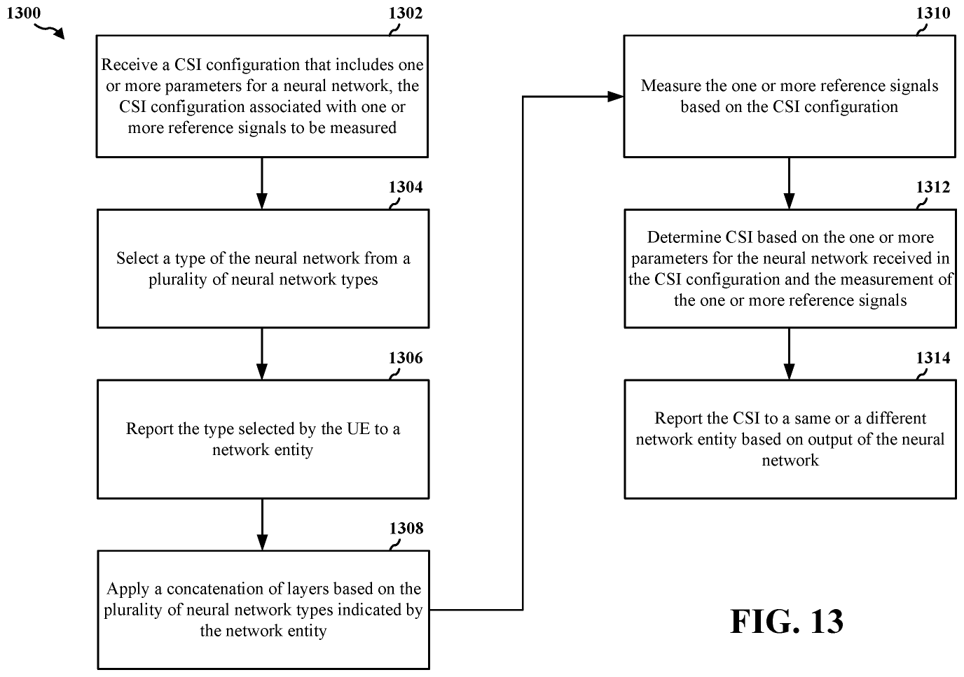

FIG. 13 is a flowchart 1300 of a method of wireless communication. The method may be performed by a UE (e.g., the UE 104/1102; the apparatus 1602, etc.), which may include the memory 360 and which may be the entire UE 104/1102 or a component of the UE 104/1102, such as the TX processor 368, the RX processor 356, and/or the controller/processor 359. The method may be performed to provide improved channel feedback and compression techniques for decreasing interference at a device.

At 1302, the UE may receive a CSI configuration that includes one or more parameters for a neural network, the CSI configuration associated with one or more reference signals to be measured. For example, referring to FIG. 11, the UE 1102 may receive, at 1106a, a CSI configuration having one or more parameters 1106b for the neural network. The UE 1102 may associate the CSI configuration received, at 1106a, with the one or more reference signals received at 1113a. The reception, at 1302, may be performed by the reception component 1630 of the apparatus 1602 in FIG. 16.

In a first example, the one or more parameters 1106b received, at 1106a, in the CSI configuration may include at least one of a first sequence/first ordered sequence of layers of the neural network (e.g., 1106b(1)), an input parameter for at least one of the layers of the neural network (e.g., 1106b(2)), an output parameter for at least one of the layers of the neural network (e.g., 1106b(2)), a layer type for at least one of the layers of the neural network (e.g., 1106b(4)), or a second sequence/second ordered sequence of sub-layers of at least one of the layers of the neural network (e.g., 406b(1)).

In a second example, the one or more parameters 1106b may include at least one of a first periodicity of reporting of the channel state information (e.g., 1106b(5)), a second periodicity of reporting of a weight of at least one layer of the neural network (e.g., 1106b(3) and (5)), or a channel resource ID indicating a resource for reporting the channel state information (e.g., 1106b(6)). The channel resource ID may be associated with an uplink channel, such as a PUCCH or a PUSCH, or a sidelink channel, such as a PSCCH or a PSSCH.

In a third example, the one or more parameters 1106b received, at 1106a, in the CSI configuration may indicate to the UE 1102 to report at least one of an output of the neural network (e.g., 1106b(2)) or a weight of at least one layer of the neural network (e.g., 1106b(3)).

In a fourth example, the one or more parameters 1106b received, at 1106a, in the CSI configuration may indicate to the UE to provide an interference channel measurement (e.g., 1106b(7)) based on the neural network and the measurement of the one or more reference signals. In aspects, the UE 1102 may apply a same neural network for the interference channel measurement as for a channel measurement or the UE 1102 may apply a different neural network for the interference channel measurement than a channel measurement. In further aspects, a first neural network for the interference channel measurement may be based, at least in part, on a second neural network for the channel measurement.

In a fifth example, the one or more parameters 1106b received, at 1106a, in the CSI configuration may include a number of subbands for reporting the CSI (e.g., 1106b(9)). The UE 1102 may report an individual vector for each subband or the UE 1102 may differentially report vectors for each subband.

In a sixth example, the one or more parameters 1106b received, at 1106a, in the CSI configuration may include a PRG to be applied for scheduling the UE 1102 (e.g., 1106b(9)).

In a seventh example, the one or more parameters 1106b received, at 1106a, in the CSI configuration may include a β parameter that is based on a sub-type of the neural network, the β parameter indicative of available PUSCH or PSSCH resources for reporting the CSI (e.g., 1106b(10)). The β parameter may be configured for one or more subsets of layers included in layers of the neural network.

At 1304, if the one or more parameters received in the CSI configuration includes an indication of a plurality of neural network types, the UE may select a type of the neural network from the plurality of neural network types. For example, referring to FIG. 11, the UE 1102 may select, at 1108, a type of the neural network from a plurality of neural network types based on the indication of the neural network type(s) received at 1106a. The one or more parameters 1106b received, at 1106a, in the CSI configuration may include the indication of at least one type of the neural network. The type of the neural network may correspond to a defined sequence of layers. The selection, at 1304, may be performed by the selection component 1640 of the apparatus 1602 in FIG. 16.

At 1306, the UE may report the type selected by the UE to a network entity (e.g., a base station, a second UE, a server, a TRP). The network entity may be a same network entity as the network entity from which the CSI configuration is received or a different network entity (e.g., second network entity) than the network entity from which the CSI configuration is received. For example, referring to FIG. 11, the UE 1102 may report, at 1110, to the network entity 1104 a report of the selected type of neural network. Additionally or alternatively, the UE 1102 may provide the report to a different network entity than the network entity 1104. The reporting, at 1306, may be performed by the reporter component 1642 of the apparatus 1602 in FIG. 16.

At 1308, if the indication indicates a plurality of neural network types, the UE may apply a concatenation of layers based on the plurality of neural network types indicated by the network entity. For example, referring to FIG. 11, if the UE 1102 receives, at 1106a, an indication of a plurality of network types including layers to be concatenated, the UE 1102 may apply, at 1112, a concatenation of the layers of the neural network. The application, at 1308, may be performed by the application component 1644 of the apparatus 1602 in FIG. 16.

At 1310, the UE may measure the one or more reference signals based on the CSI configuration. For example, referring to FIG. 11, the UE 1102 may measure, at 1113b, the reference signal(s) received, at 1113a, based on the CSI configuration received at 1106a. The measurement, at 1310, may be performed by the measurement component 1646 of the apparatus 1602 in FIG. 16.

At 1312, the UE may determine CSI based on the one or more parameters for the neural network received in the CSI configuration and the measurement of the one or more reference signals. For example, referring to FIG. 11, the UE 1102 may determine, at 1114, CSI based on the one or more parameters 1106b of the neural network received at 1106a and the measurement, at 1113b, of the reference signals(s). The determination, at 1312, may be performed by the determination component 1648 of the apparatus 1602 in FIG. 16.

At 1314, the UE may report the CSI to the network entity based on output of the neural network. For example, referring to FIG. 11, the UE 1102 may report, at 1116, CSI to the network entity 1104 based on the output of the neural network. The reporting, at 1314, may be performed by the reporter component 1642 of the apparatus 1602 in FIG. 16.

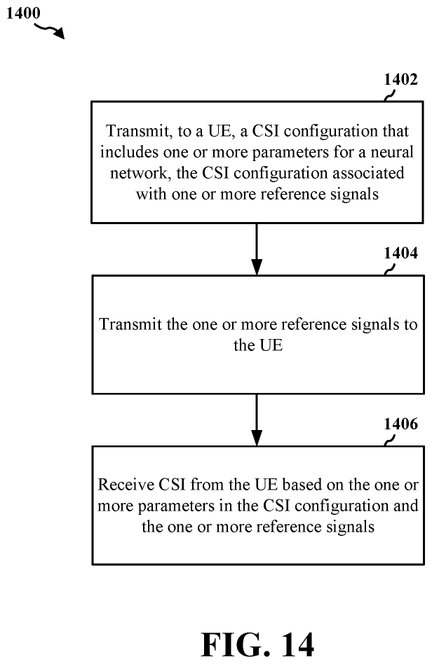

FIG. 14 is a flowchart 1400 of a method of wireless communication. The method may be performed by a network entity (e.g., the network entity 1104, a base station 102, a second UE 104, a server 174, a TRP 103; the apparatus 1702; etc.). In examples, the network entity 1104 may include the memory 376, which may be the entire network entity 1104 or a component of the network entity 1104, such as the TX processor 316, the RX processor 370, and/or the controller/processor 375. The method may be performed to provide improved channel feedback and compression techniques for decreasing interference at a device.

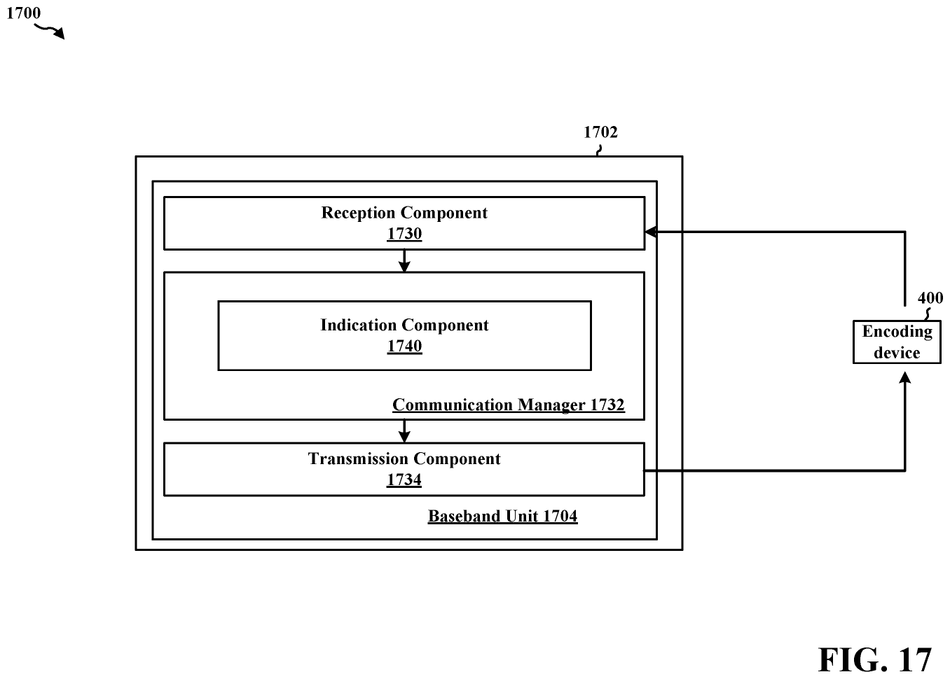

At 1402, the network entity may transmit, to a UE, a CSI configuration that includes one or more parameters for a neural network, the CSI configuration associated with one or more reference signals. For example, referring to FIG. 11, the network entity 1104 may transmit, at 1106a, a CSI configuration having one or more parameters 1106b for the neural network to the UE 1102. One or more reference signals transmitted, at 1113a, may be associated with the CSI configuration transmitted at 1106a. The transmission, at 1402, may be performed by the transmission component 1734 of the apparatus 1702 in FIG. 17.

At 1404, the network entity may transmit the one or more reference signals to the UE. For example, referring to FIG. 11, the network entity 1104 may transmit, at 1113a, the one or more reference signals to the UE 1102 associated with the CSI configuration transmitted, at 1106a, to the UE 1102. The transmission, at 1404, may be performed by the transmission component 1734 of the apparatus 1702 in FIG. 17.

At 1406, the network entity may receive CSI from the UE based on the one or more parameters in the CSI configuration and the one or more reference signals. For example, referring to FIG. 11, the network entity 1104 may receive CSI, at 1116, from the UE 1102 based on the one or more parameters 1106b transmitted, at 1106a, in the CSI configuration and the one or more reference signals transmitted at 1113a. The CSI received, at 1116, from the UE 1102 may be based on application of a same neural network for the interference channel measurement as for a channel measurement or the CSI received, at 1116, from the UE 1102 may be based on application of a different neural network for the interference channel measurement than a channel measurement. In aspects, a first neural network for the interference channel measurement may be based, at least in part, on a second neural network for the channel measurement. The reception, at 1406, may be performed by the reception component 1730 of the apparatus 1702 in FIG. 17.

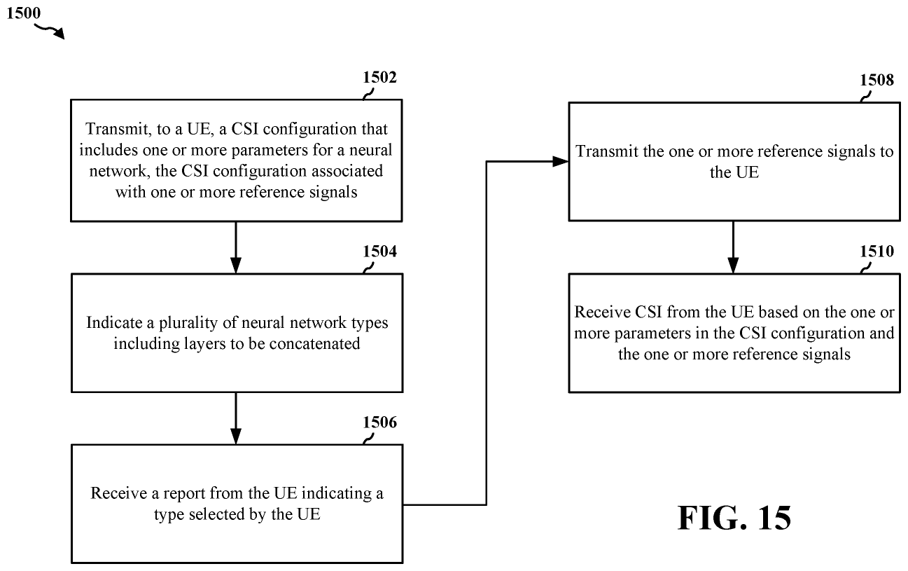

FIG. 15 is a flowchart 1500 of a method of wireless communication. The method may be performed by a network entity (e.g., the network entity 1104, a base station 102, a second UE 104, a server 174, a TRP 103; the apparatus 1702; etc.). In examples, the network entity 1104 may include the memory 376, which may be the entire network entity 1104 or a component of the network entity 1104, such as the TX processor 316, the RX processor 370, and/or the controller/processor 375. The method may be performed to provide improved channel feedback and compression techniques for decreasing interference at a device.

At 1502, the network entity may transmit, to a UE, a CSI configuration that includes one or more parameters for a neural network, the CSI configuration associated with one or more reference signals. For example, referring to FIG. 11, the network entity 1104 may transmit, at 1106a, a CSI configuration having one or more parameters 1106b for the neural network to the UE 1102. One or more reference signals transmitted, at 1113a, may be associated with the CSI configuration transmitted at 1106a. The transmission, at 1502, may be performed by the transmission component 1734 of the apparatus 1702 in FIG. 17.

In a first example, the one or more parameters 1106b transmitted, at 1106a, in the CSI configuration may include at least one of a first sequence/first ordered sequence of layers of the neural network (e.g., 1106b(1)), an input parameter for at least one of the layers of the neural network (e.g., 1106b(2)), an output parameter for at least one of the layers of the neural network (e.g., 1106b(2)), a layer type for at least one of the layers of the neural network (e.g., 1106b(4)), or a second sequence/second ordered sequence of sub-layers of at least one of the layers of the neural network (e.g., 1106b(1)).

In a second example, the one or more parameters 1106b may include at least one of a first periodicity of reporting of the channel state information (e.g., 1106b(5)), a second periodicity of reporting of a weight of at least one layer of the neural network (e.g., 1106b(3) and (5)), or a channel resource ID indicating a resource for receiving the channel state information (e.g., 1106b(6)). The channel resource ID may be associated with an uplink channel, such as a PUCCH or a PUSCH, or a sidelink channel, such as a PSCCH or a PSSCH.

In a third example, the one or more parameters 1106b transmitted, at 1106a, in the CSI configuration may indicate to the UE 1102 to report at least one of an output of the neural network (e.g., 1106b(2)) or a weight of at least one layer of the neural network (e.g., 1106b(3)).

In a fourth example, the one or more parameters 1106b transmitted, at 1106a, in the CSI configuration may indicate to the UE to provide an interference channel measurement (e.g., 1106b(7)) based on the neural network and the one or more resources.

In a fifth example, the one or more parameters 1106b transmitted, at 1106a, in the CSI configuration may include a number of subbands for receiving a report of CSI (e.g., 1106b(9)). The report may include an individual vector for each subband or differential receive vectors for each subband.

In a sixth example, the one or more parameters 1106b transmitted, at 1106a, in the CSI configuration may include a PRG to be applied for scheduling the UE 1102 (e.g., 1106b(9)).

In a seventh example, the one or more parameters 1106b transmitted, at 1106a, in the CSI configuration may include a β parameter that is based on a sub-type of the neural network, the β parameter indicative of available PUSCH or PSSCH resources for receiving the report of the CSI (e.g., 1106b(10)). The β parameter may be configured for one or more subsets of layers included in layers of the neural network.

At 1504, if the one or more parameters transmitted in the CSI configuration includes an indication of a plurality of network types, the network entity may indicate a plurality of neural network types including layers to be concatenated. For example, referring to FIG. 11, the network entity 1104 may transmit, at 1106a, the indication of the network type(s) including layers to be concatenated. The one or more parameters 1106b transmitted, at 1106a, in the CSI configuration may include an indication of at least one type of the neural network. The type of the neural network may correspond to a defined sequence of layers. The indication, at 1504, may be performed by the indication component 1740 of the apparatus 1702 in FIG. 17.

At 1506, if the indication indicates a plurality of neural network types, the network entity may receive a report from the UE indicating a type selected by the UE. For example, referring to FIG. 11, the network entity 1104 may receive, at 1110, a report of the selected type of neural network from the UE 1102. The reception, at 1506, may be performed by the reception component 1730 of the apparatus 1702 in FIG. 17.

At 1508, the network entity may transmit the one or more reference signals to the UE. For example, referring to FIG. 11, the network entity 1104 may transmit, at 1113a, the one or more reference signals to the UE 1102 associated with the CSI configuration transmitted, at 1106a, to the UE 1102. The transmission, at 1508, may be performed by the transmission component 1734 of the apparatus 1702 in FIG. 17.

At 1510, the network entity may receive CSI from the UE based on the one or more parameters in the CSI configuration and the one or more reference signals. For example, referring to FIG. 11, the network entity 1104 may receive CSI, at 1116, from the UE 1102 based on the one or more parameters 1106b transmitted, at 1106a, in the CSI configuration and the one or more reference signals transmitted at 1113a. The CSI received, at 1116, from the UE 1102 may be based on application of a same neural network for the interference channel measurement as for a channel measurement or the CSI received, at 1116, from the UE 1102 may be based on application of a different neural network for the interference channel measurement than a channel measurement. In aspects, a first neural network for the interference channel measurement may be based, at least in part, on a second neural network for the channel measurement. The reception, at 1510, may be performed by the reception component 1730 of the apparatus 1702 in FIG. 17.

FIG. 16 is a diagram 1600 illustrating an example of a hardware implementation for an apparatus 1602. The apparatus 1602 is a UE or an encoding device (e.g., encoding device 400) and includes a cellular baseband processor 1604 (also referred to as a modem) coupled to a cellular RF transceiver 1622 and one or more subscriber identity modules (SIM) cards 1620, an application processor 1606 coupled to a secure digital (SD) card 1608 and a screen 1610, a Bluetooth module 1612, a wireless local area network (WLAN) module 1614, a Global Positioning System (GPS) module 1616, and a power supply 1618. The cellular baseband processor 1604 communicates through the cellular RF transceiver 1622 with the UE 104 and/or BS 102/180. The cellular baseband processor 1604 may include a computer-readable medium/memory. The computer-readable medium/memory may be non-transitory. The cellular baseband processor 1604 is responsible for general processing, including the execution of software stored on the computer-readable medium/memory. The software, when executed by the cellular baseband processor 1604, causes the cellular baseband processor 1604 to perform the various functions described supra. The computer-readable medium/memory may also be used for storing data that is manipulated by the cellular baseband processor 1604 when executing software. The cellular baseband processor 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the cellular baseband processor 1604. The cellular baseband processor 1604 may be a component of the UE 350 and may include the memory 360 and/or at least one of the TX processor 368, the RX processor 356, and the controller/processor 359. In one configuration, the apparatus 1602 may be a modem chip and include just the cellular baseband processor 1604, and in another configuration, the apparatus 1602 may be the entire UE (e.g., see 350 of FIG. 3) and include the additional modules of the apparatus 1602.

The reception component 1630 may be configured, e.g., as described in connection with 1202 and 1302, to receive a CSI configuration that includes one or more parameters for a neural network, the CSI configuration associated with one or more reference signals to be measured. The communication manager 1632 includes a selection component 1640 that may be configured, e.g., as described in connection with 1304, to select a type of the neural network from a plurality of neural network types. The communication manager 1632 may further include a reporter component 1642 that may be configured, e.g., as described in connection with 1206, 1306, and 1314, to report the type selected by the UE to the network entity; and to report the CSI to a same or a different network entity based on output of the neural network. The communication manager 1632 may further includes an application component 1644 that may be configured, e.g., as described in connection with 1308, to apply a concatenation of layers based on the plurality of neural network types indicated by the network entity. The communication manager 1632 may further includes a measurement component 1646 that may be configured, e.g., as described in connection with 1204 and 1310, to measure the one or more reference signals based on the CSI configuration. The communication manager 1632 may further includes a determination component 1648 that may be configured, e.g., as described in connection with 1312, to determine CSI based on the one or more parameters for the neural network received in the CSI configuration and the measurement of the one or more reference signals.

The apparatus may include additional components that perform each of the blocks of the algorithm in the aforementioned flowcharts of FIGS. 12-13. As such, each block in the aforementioned flowcharts of FIGS. 12-13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1602, and in particular the cellular baseband processor 1604, includes means for receiving a CSI configuration that includes one or more parameters for a neural network, the CSI configuration associated with one or more reference signals to be measured; means for measuring the one or more reference signals based on the CSI configuration; means for determining CSI based on the one or more parameters for the neural network received in the CSI configuration and the measurement of the one or more reference signals; and means for reporting the CSI to a network entity based on output of the neural network. The apparatus 1602 may further include means for selecting a type from the plurality of neural network types; and means for reporting the type selected by the UE to a second network entity, the second network entity being a same network entity as the network entity or a different network entity than the network entity. The apparatus 1602 may further include means for applying a concatenation of layers based on the plurality of neural network types indicated by the network entity. The aforementioned means may be one or more of the aforementioned components of the apparatus 1602 configured to perform the functions recited by the aforementioned means. As described supra, the apparatus 1602 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

FIG. 17 is a diagram 1700 illustrating an example of a hardware implementation for an apparatus 1702. The apparatus 1702 is a network entity, such as a base station, a TRP, a UE, or a decoding device (e.g., decoding device 425) and includes a baseband unit 1704. The baseband unit 1704 may communicate through a cellular RF transceiver with the UE 104. The baseband unit 1704 may include a computer-readable medium/memory. The baseband unit 1704 is responsible for general processing, including the execution of software stored on the computer-readable medium/memory. The software, when executed by the baseband unit 1704, causes the baseband unit 1704 to perform the various functions described supra. The computer-readable medium/memory may also be used for storing data that is manipulated by the baseband unit 1704 when executing software. The baseband unit 1704 further includes a reception component 1730, a communication manager 1732, and a transmission component 1734. The communication manager 1732 includes the one or more illustrated components. The components within the communication manager 1732 may be stored in the computer-readable medium/memory and/or configured as hardware within the baseband unit 1704. The baseband unit 1704 may be a component of a network entity, such as a base station 310, TRP, UE, etc., and may include the memory 376 and/or at least one of the TX processor 316, the RX processor 370, and the controller/processor 375.

The reception component 1730 may be configured, e.g., as described in connection with 1406, 1506 and 1510, to receive a report from the UE indicating a type selected by the UE; and to receive CSI from the UE based on the one or more parameters in the CSI configuration and the one or more reference signals. The communication manager 1732 includes an indication component 1740 that may be configured, e.g., as described in connection with 1504, to indicate a plurality of neural network types including layers to be concatenated. The transmission component 1734 may be configured, e.g., as described in connection with 1402, 1404, 1502, and 1508, to transmit, to a UE, a CSI configuration that includes one or more parameters for a neural network, the CSI configuration associated with one or more reference signals; and to transmit the one or more reference signals to the UE.

The apparatus may include additional components that perform each of the blocks of the algorithm in the aforementioned flowcharts of FIG. 14-15. As such, each block in the aforementioned flowcharts of FIGS. 14-15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1702, and in particular the baseband unit 1704, includes means for transmitting, to a UE, a CSI configuration that includes one or more parameters for a neural network, the CSI configuration associated with one or more reference signals; means for transmitting the one or more reference signals to the UE; and means for receiving CSI from the UE based on the one or more parameters in the CSI configuration and the one or more reference signals. The apparatus 1702 may further include means for receiving a report from the UE indicating a type selected by the UE. The apparatus 1702 may further include means for indicating the plurality of neural network types including layers to be concatenated. The aforementioned means may be one or more of the aforementioned components of the apparatus 1702 configured to perform the functions recited by the aforementioned means. As described supra, the apparatus 1702 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE including at least one processor coupled to a memory and configured to receive a CSI configuration that includes one or more parameters for a neural network, the CSI configuration associated with one or more reference signals to be measured; measure the one or more reference signals based on the CSI configuration, a CSI being based on the one or more parameters for the neural network received in the CSI configuration and a measurement of the one or more reference signals; and report the CSI to a network entity based on output of the neural network.

Aspect 2 may be combined with aspect 1 and includes that a first sequence of layers of the neural network, an input parameter for at least one layer of the neural network, an output parameter for at least one layer of the neural network, a layer type for at least one of the layers of the neural network, or a second sequence of sub-layers of at least one layer of the neural network.

Aspect 3 may be combined with any of aspects 1-2 and includes that the first sequence of layers is a first ordered sequence of layers of the neural network, and wherein the second sequence of sub-layers is a second ordered sequence of sub-layers of the at least one layer of the neural network.

Aspect 4 may be combined with any of aspects 1-3 and includes that the one or more parameters received in the CSI configuration includes an indication of at least one type of the neural network, the at least one type corresponding to a defined sequence of layers.

Aspect 5 may be combined with any of aspects 1-4 and includes that the indication indicates a plurality of neural network types, the at least one processor further configured to: select a type from the plurality of neural network types; and report the type selected by the UE to a second network entity, the second network entity being a same network entity as the network entity or a different network entity than the network entity.

Aspect 6 may be combined with any of aspects 1-5 and includes that the indication indicates a plurality of neural network types, the at least one processor further configured to: apply a concatenation of layers based on the plurality of neural network types indicated by the network entity.

Aspect 7 may be combined with any of aspects 1-6 and includes that the one or more parameters includes at least one of: a first periodicity of reporting of the channel state information, a second periodicity of reporting of a weight of at least one layer of the neural network, or a channel resource ID indicating a resource for reporting the channel state information.

Aspect 8 may be combined with any of aspects 1-7 and includes that the one or more parameters received in the CSI configuration indicates to the UE to report at least one of: the output of the neural network, or a weight of at least one layer of the neural network.

Aspect 9 may be combined with any of aspects 1-8 and includes that the one or more parameters received in the CSI configuration indicates for the UE to provide an interference channel measurement based on the neural network and the measurement of the one or more reference signals.

Aspect 10 may be combined with any of aspects 1-9 and includes that the UE applies a same neural network for the interference channel measurement as for a channel measurement.

Aspect 11 may be combined with any of aspects 1-10 and includes that the UE applies a different neural network for the interference channel measurement than a channel measurement.

Aspect 12 may be combined with any of aspects 1-11 and includes that a first neural network for the interference channel measurement is based, at least in part, on a second neural network for the channel measurement.

Aspect 13 may be combined with any of aspects 1-12 and includes that the one or more parameters received in the CSI configuration includes a number of subbands for reporting the CSI.

Aspect 14 may be combined with any of aspects 1-13 and includes that the UE reports an individual vector for each subband or differentially reports vectors for each subband.

Aspect 15 may be combined with any of aspects 1-14 and includes that the one or more parameters received in the CSI configuration includes a PRG to be applied for scheduling the UE.

Aspect 16 may be combined with any of aspects 1-15 and includes that the one or more parameters received in the CSI configuration includes a beta (β) parameter that is based on a sub-type of the neural network, the β parameter indicative of available PUSCH or PSSCH resources for reporting the CSI.

Aspect 17 may be combined with any of aspects 1-16 and includes that the β parameter is configured for one or more subsets of layers included in layers of the neural network.

Aspect 18 is an apparatus for wireless communication at a base station including at least one processor coupled to a memory and configured to transmit, to a UE, a CSI configuration that includes one or more parameters for a neural network, the CSI configuration associated with one or more reference signals; transmit the one or more reference signals to the UE; and receive CSI from the UE based on the one or more parameters in the CSI configuration and the one or more reference signals.

Aspect 19 may be combined with aspect 18 and includes that the one or more parameters transmitted in the CSI configuration includes at least one of: a first sequence of layers of the neural network, an input parameter for at least one of the layers of the neural network, an output parameter for at least one of the layers of the neural network, a layer type for at least one of the layers of the neural network, or a second sequence of sub-layers of at least one of the layers of the neural network.

Aspect 20 may be combined with any of aspects 18-19 and includes that the first sequence of layers is a first ordered sequence of layers of the neural network, and wherein the second sequence of sub-layers is a second ordered sequence of sub-layers of the at least one of the layers of the neural network.

Aspect 21 may be combined with any of aspects 18-20 and includes that the one or more parameters transmitted in the CSI configuration includes an indication of at least one type of the neural network, the at least one type corresponding to a defined sequence of layers.

Aspect 22 may be combined with any of aspects 18-21 and includes that the indication indicates a plurality of neural network types, the at least one processor further configured to: receive a report from the UE indicating a type selected by the UE.

Aspect 23 may be combined with any of aspects 18-22 and includes that the indication indicates a plurality of neural network types, the at least one processor further configured to: indicate the plurality of neural network types including layers to be concatenated.

Aspect 24 may be combined with any of aspects 18-23 and includes that the one or more parameters includes at least one of: a first periodicity of reporting of the CSI, a second periodicity of reporting of a weight of at least one layer of the neural network, or a channel resource ID indicating a resource for receiving a report of the CSI.

Aspect 25 may be combined with any of aspects 18-24 and includes that the one or more parameters transmitted in the CSI configuration indicates to the UE to report at least one of: an output of the neural network, or a weight of at least one layer of the neural network.

Aspect 26 may be combined with any of aspects 18-25 and includes that the one or more parameters transmitted in the CSI configuration indicates to the UE to provide an interference channel measurement based on the neural network and the one or more reference signals.

Aspect 27 may be combined with any of aspects 18-26 and includes that the CSI received from the UE is based on application of a same neural network for the interference channel measurement as for a channel measurement.

Aspect 28 may be combined with any of aspects 18-27 and includes that the CSI received from the UE is based on application of a different neural network for the interference channel measurement than a channel measurement.

Aspect 29 may be combined with any of aspects 18-28 and includes that a first neural network for the interference channel measurement is based, at least in part, on a second neural network for the channel measurement.

Aspect 30 may be combined with any of aspects 18-29 and includes that the one or more parameters transmitted in the CSI configuration includes a number of subbands for receiving a report of the CSI.

Aspect 31 may be combined with any of aspects 18-30 and includes that the report includes an individual vector for each subband or differential vectors for each subband.

Aspect 32 may be combined with any of aspects 18-31 and includes that the one or more parameters transmitted in the CSI configuration includes a PRG to be applied for scheduling the UE.

Aspect 33 may be combined with any of aspects 18-32 and includes that the one or more parameters transmitted in the CSI configuration includes a beta (β) parameter that is based on a sub-type of the neural network, the β parameter indicative of available PUSCH or PSSCH resources for receiving a report of the CSI.

Aspect 34 may be combined with any of aspects 18-33 and includes that the β parameter is configured for one or more subsets of layers included in layers of the neural network.

Aspect 35 is a method of wireless communication for implementing any of aspects 1-34.

Aspect 36 is an apparatus for wireless communication including means for implementing any of aspects 1-34.

Aspect 37 is a computer-readable medium storing computer executable code, the code when executed by at least one processor causes the at least one processor to implement any of aspects 1-34.

What is claimed is:

1. An apparatus for wireless communication at a user equipment (UE), comprising:
a memory; and
at least one processor coupled to the memory and configured to:
receive a channel state information (CSI) configuration that includes one or more parameters for a neural network, the CSI configuration associated with one or more reference signals to be measured;
measure the one or more reference signals based on the CSI configuration, a CSI being based on the one or more parameters for the neural network received in the CSI configuration and a measurement of the one or more reference signals; and
report the CSI to a network entity based on output of the neural network.

2. The apparatus of claim 1, wherein the one or more parameters received in the CSI configuration includes at least one of:
a first sequence of layers of the neural network,
an input parameter for at least one layer of the neural network,
an output parameter for at least one layer of the neural network,
a layer type for at least one layer of the neural network, or
a second sequence of sub-layers of at least one layer of the neural network.

3. The apparatus of claim 2, wherein the first sequence of layers is a first ordered sequence of layers of the neural network, and wherein the second sequence of sub-layers is a second ordered sequence of sub-layers of the at least one layer of the neural network.

4. The apparatus of claim 1, wherein the one or more parameters received in the CSI configuration includes an indication of at least one type of the neural network, the at least one type corresponding to a defined sequence of layers.

5. The apparatus of claim 4, wherein the indication indicates a plurality of neural network types, the at least one processor further configured to:
select a type from the plurality of neural network types; and
report the type selected by the UE to a second network entity, the second network entity being a same network entity as the network entity or a different network entity than the network entity.

6. The apparatus of claim 4, wherein the indication indicates a plurality of neural network types, the at least one processor further configured to:
apply a concatenation of layers based on the plurality of neural network types indicated by the network entity.

7. The apparatus of claim 4, wherein the one or more parameters includes at least one of:
a first periodicity of reporting of the channel state information,
a second periodicity of reporting of a weight of at least one layer of the neural network, or
a channel resource identifier (ID) indicating a resource for reporting the channel state information.

8. The apparatus of claim 1, wherein the one or more parameters received in the CSI configuration indicates to the UE to report at least one of:
the output of the neural network, or
a weight of at least one layer of the neural network.

9. The apparatus of claim 1, wherein the one or more parameters received in the CSI configuration indicates for the UE to provide an interference channel measurement based on the neural network and the measurement of the one or more reference signals.

10. The apparatus of claim 9, wherein the UE applies a same neural network for the interference channel measurement as for a channel measurement.

11. The apparatus of claim 9, wherein the UE applies a different neural network for the interference channel measurement than a channel measurement, and wherein a first neural network for the interference channel measurement is based, at least in part, on a second neural network for the channel measurement.

12. The apparatus of claim 1, wherein the one or more parameters received in the CSI configuration includes a number of subbands for reporting the CSI, and wherein the UE reports an individual vector for each subband or differentially reports vectors for each subband.

13. The apparatus of claim 1, wherein the one or more parameters received in the CSI configuration includes a precoder resource group (PRG) to be applied for scheduling the UE.

14. The apparatus of claim 1, wherein the one or more parameters received in the CSI configuration includes a beta (β) parameter that is based on a sub-type of the neural network, the β parameter indicative of available physical uplink shared channel (PUSCH) or physical sidelink shared channel (PSSCH) resources for reporting the CSI.

15. An apparatus for wireless communication at a network entity, comprising:
a memory; and
at least one processor coupled to the memory and configured to:
transmit, to a user equipment (UE), a channel state information (CSI) configuration that includes one or more parameters for a neural network, the CSI configuration associated with one or more reference signals;
transmit the one or more reference signals to the UE; and
receive CSI from the UE based on the one or more parameters in the CSI configuration and the one or more reference signals.

16. The apparatus of claim 15, wherein the one or more parameters transmitted in the CSI configuration includes at least one of:
a first sequence of layers of the neural network,
an input parameter for at least one of the layers of the neural network,
an output parameter for at least one of the layers of the neural network,
a layer type for at least one of the layers of the neural network, or
a second sequence of sub-layers of at least one of the layers of the neural network.

17. The apparatus of claim 16, wherein the first sequence of layers is a first ordered sequence of layers of the neural network, and wherein the second sequence of sub-layers is a second ordered sequence of sub-layers of the at least one of the layers of the neural network.

18. The apparatus of claim 15, wherein the one or more parameters transmitted in the CSI configuration includes an indication of at least one type of the neural network, the at least one type corresponding to a defined sequence of layers.

19. The apparatus of claim 18, wherein the indication indicates a plurality of neural network types, the at least one processor further configured to:
receive a report from the UE indicating a type selected by the UE.

20. The apparatus of claim 18, wherein the indication indicates a plurality of neural network types, the at least one processor further configured to:
indicate the plurality of neural network types including layers to be concatenated.

21. The apparatus of claim 18, wherein the one or more parameters includes at least one of:
a first periodicity of reporting of the CSI,
a second periodicity of reporting of a weight of at least one layer of the neural network, or
a channel resource identifier (ID) indicating a resource for receiving a report of the CSI.

22. The apparatus of claim 15, wherein the one or more parameters transmitted in the CSI configuration indicates to the UE to report at least one of:
an output of the neural network, or
a weight of at least one layer of the neural network.

23. The apparatus of claim 15, wherein the one or more parameters transmitted in the CSI configuration indicates to the UE to provide an interference channel measurement based on the neural network and the one or more reference signals.

24. The apparatus of claim 23, wherein the CSI received from the UE is based on application of a same neural network for the interference channel measurement as for a channel measurement.

25. The apparatus of claim 23, wherein the CSI received from the UE is based on application of a different neural network for the interference channel measurement than a channel measurement, and wherein a first neural network for the interference channel measurement is based, at least in part, on a second neural network for the channel measurement.

26. The apparatus of claim 15, wherein the one or more parameters transmitted in the CSI configuration includes a number of subbands for receiving a report of the CSI, and wherein the report includes an individual vector for each subband or differential vectors for each subband.

27. The apparatus of claim 15, wherein the one or more parameters transmitted in the CSI configuration includes a precoder resource group (PRG) to be applied for scheduling the UE.

28. The apparatus of claim 15, wherein the one or more parameters transmitted in the CSI configuration includes a beta (β) parameter that is based on a sub-type of the neural network, the β parameter indicative of available physical uplink shared channel (PUSCH) or physical sidelink shared channel (PSSCH) resources for receiving a report of the CSI.

29. A method of wireless communication at a user equipment (UE), comprising:
receiving a channel state information (CSI) configuration that includes one or more parameters for a neural network, the CSI configuration associated with one or more reference signals to be measured;
measuring the one or more reference signals based on the CSI configuration, a CSI being based on the one or more parameters for the neural network received in the CSI configuration and a measurement of the one or more reference signals; and
reporting the CSI to a network entity based on output of the neural network.

30. A computer-readable medium storing computer executable code at a user equipment (UE), the code when executed by at least one processor causes the at least one processor to:
receive a channel state information (CSI) configuration that includes one or more parameters for a neural network, the CSI configuration associated with one or more reference signals to be measured;
measure the one or more reference signals based on the CSI configuration, a CSI being based on the one or more parameters for the neural network received in the CSI configuration and a measurement of the one or more reference signals; and
report the CSI to a network entity based on output of the neural network.
